(19) United States
(12) Patent Application Publication
(10) Pub. No.: US 2026/0179505 A1
(43) Pub. Date: Jun. 25, 2026

(54) SYSTEMS AND METHODS FOR DEVELOPING INTERMEDIATE READING SKILLS, AND RELATED STORIES, BOOKS, AND COMPUTER PROGRAM PRODUCTS

(71) Applicant: Treasure Bay, Inc., Granite Bay, CA (US)

(72) Inventor: Donald J. Panec, Granite Bay, CA (US)

(21) Appl. No.: 19/427,760

(22) Filed: Dec. 19, 2025

Related U.S. Application Data
(60) Provisional application No. 63/738,318, filed on Dec. 23, 2024.

(51) Int. Cl. G09B 17/00; G09B 5/02

(52) U.S. Cl. CPC G09B 17/003; G09B 5/02

(57) ABSTRACT

Systems, stories, books, and methods for developing reading skills are disclosed. The stories include a plurality of words, including a plurality of sight words, a plurality of decodable words, and a plurality of non-decodable, non-sight (“NDNS”) words that are neither sight words nor decodable words. For each of at least a substantial portion of the plurality of NDNS words, the story includes a discrete pronunciation key (DPK) immediately adjacent to at least an initial appearance of each NDNS word of the at least a substantial portion of the plurality of NDNS words. The story is constructed to be a preselected reading level, and at least a portion of the plurality of words, optionally including at least a substantial portion of the NDNS words, may be selected, at least in part, based on the preselected reading level. Books and systems including one or more of the stories also are disclosed.

### RELATED APPLICATION

The present application claims priority under 35 U.S.C. § 119 to similarly titled U.S. Provisional Patent Application No. 63/738,318, which was filed on Dec. 23, 2024, and the complete disclosure of which is incorporated by reference.

### FIELD OF THE DISCLOSURE

The present disclosure relates generally to systems and methods for developing reading skills and assisting in the reading of text, and to stories, books, and computer program products embodying the systems and/or methods.

### BACKGROUND OF THE DISCLOSURE

When a child or other individual is learning to read, they typically do so by learning to recognize certain words by their appearance (i.e., whole word or word or sight-word recognition) and/or by learning to read words phonetically. Most written words are formed from graphemes, which are the letters or digraphs (groups of letters) of a writing system, and which correspond to phonemes, which are the individual speech sounds that correspond to the graphemes. By learning the graphemes and how they correspond to phonemes, beginning readers are able to sound out, or decode, such words, typically one grapheme at a time. Readers are taught grapheme/phoneme relationships and especially beginning and intermediate readers may know some of the relationships, but not others. If a reader encounters too many words that the reader cannot read, the reader may struggle to read that text. A reader may struggle to read words for a number of reasons. One reason is if a text presents the reader with too many words that cannot be read by sight or phonetically. Some words do not have graphemes with phoneme relationships that the reader has learned, and other words are irregular in that the word cannot be sounded out or decoded using the grapheme/phoneme relationships that are typically learned by readers at a particular reading level. A reader may also struggle to read words that are long and/or that have unusual syllable breaks, resulting in confusion of how to decode the word. For example, the word “retribution” may be difficult or impossible for a reader to decode due to one or a combination of the factors mentioned above. Also, some words that appear in text are not formed entirely from graphemes that have been learned by a reader or that are typically taught at a particular reading level and thus cannot be sounded out or otherwise decoded by the reader by analyzing the graphemes in the words.

Some such words that appear in high frequency in reading passages come to be recognized by beginning readers based on their appearance. Through repetition and memorization, beginning readers are able to read passages containing such high-frequency words, and beginning readers can read the words by sight regardless of whether they can or cannot read the words phonetically. Such words may be referred to as sight words. Sight words that cannot be decoded by a reader may be referred to as non-decodable or irregular sight words. If a reader at a particular level of reading skill cannot read a word by sight or by decoding, these words may be referred to as non-decodable, non-sight (“NDNS”) words. Note that these words are related to the sight-word knowledge and decoding skill of a particular reader and/or at a particular reading level, and thus the NDNS words for one reader or reading level may be different from the NDNS words for other readers or other reading levels.

A recurring goal with teaching children and other less experienced readers to read is to make the learning experience enjoyable and/or free from complications that may cause the reader to be embarrassed, be frustrated, and/or otherwise not want to continue to learn to read. For such reasons, when constructing books for beginning readers, it is common to construct them mostly using fairly short words, which consist of a limited number of irregular sight words and words that can be decoded with a limited set of phonics skills. As a result, such books usually have a very simple story or, if nonfiction, are not able to go into much depth on the subject. Older children, who are struggling to read and can only easily read books at the level of such books for beginning readers, may not be interested in reading such books due to lack of interest in the story or content, or due to embarrassment at reading what they perceive to be a “baby-book” or otherwise to be a book that is intended to be read by a reader at a lower reading level than the struggling reader's classmates or peers of the same age and/or grade.

The publishing and education industries contain vast resources, including countless books constructed to be at a beginning reading level for teaching and helping beginning readers to read. Such resources and books typically are constructed to be at or below a preschool, kindergarten, first grade, or second grade reading level. However, fewer materials exist to assist intermediate readers to develop and improve their reading skills. As a particular example, conventional reading passages that are constructed to be at an intermediate (i.e., second grade through eighth grade) reading level do not include suitable resources to assist an intermediate reader when the reader does not recognize an NDNS word and/or cannot read such a word by sight or by decoding using the reader's decoding skills. Reading conventional grade-level passages can be embarrassing or frustrating to intermediate readers who are at a lower reading level than their peers, especially in group-reading or read-aloud situations. Such struggling intermediate readers also may not be willing to read passages that are constructed for lower reading levels, which may be appropriate to help the struggling intermediate reader improve their reading skills.

A need thus exists for improved systems, methods, stories, books, and computer program products for developing the reading skills of intermediate readers.

### SUMMARY OF THE DISCLOSURE

Systems, stories, books, and methods for developing intermediate reading skills are disclosed herein. The stories include a plurality of words, including a plurality of sight words, a plurality of decodable words, and a plurality of non-decodable, non-sight (“NDNS”) words that are neither sight words nor decodable words. For each of at least a substantial portion of the plurality of NDNS words, the story includes a discrete pronunciation key (DPK) immediately adjacent to at least an initial appearance of each NDNS word of the at least a substantial portion of the plurality of NDNS words. The story is constructed to be a preselected reading level, and at least a portion of the plurality of words, optionally including at least a substantial portion of the NDNS words, may be selected, at least in part, based on the preselected reading level. Books and systems including one or more of the stories also are disclosed, as are methods for creating the stories, books, and systems. Computer-implemented methods and computer program products embodying the systems, stories, books, and/or methods also are disclosed.

### BRIEF DESCRIPTION OF THE DRAWINGS

FIG. 1 schematically illustrates examples of systems according to the present disclosure.

FIG. 2 schematically illustrates examples of types of words that may be included in a story of a system according to the present disclosure.

FIG. 3 schematically illustrates examples of a discrete pronunciation key presented immediately adjacent to a corresponding non-decodable, non-sight word according to the present disclosure.

FIG. 4 is an example of a page of a story of a system according to the present disclosure.

FIG. 5 is an example of a description or introduction for a system containing a story according to the present disclosure.

FIG. 6 is an example of a master pronunciation guide for a system containing a story according to the present disclosure.

FIG. 7 is a flow chart illustrating examples of methods for creating a system containing a story according to the present disclosure.

FIG. 8 illustrates an example of a text passage for a story according to the present disclosure.

FIG. 9 illustrates an example of the text passage of FIG. 8 categorized at a first preselected reading level according to the present disclosure.

FIG. 10 illustrates an example of the text passage of FIG. 8 with NDNS words at the first selected reading level presented with DPKs according to the present disclosure.

FIG. 11 illustrates an example of the text passage of FIG. 8 categorized at a second preselected reading level according to the present disclosure.

FIG. 12 illustrates an example of the text passage of FIG. 8 with NDNS words at the second preselected reading level presented with DPKs according to the present disclosure.

FIG. 13 illustrates an example of the text passage of FIG. 8 categorized at a third preselected reading level according to the present disclosure.

FIG. 14 illustrates an example of the text passage of FIG. 8 with NDNS words at the third preselected reading level presented with DPKs according to the present disclosure.

FIG. 15 illustrates an example of a user interface for a computer program product from which a computer-implemented method may be performed, at least in part, according to the present disclosure.

### DETAILED DESCRIPTION AND BEST MODE OF THE DISCLOSURE

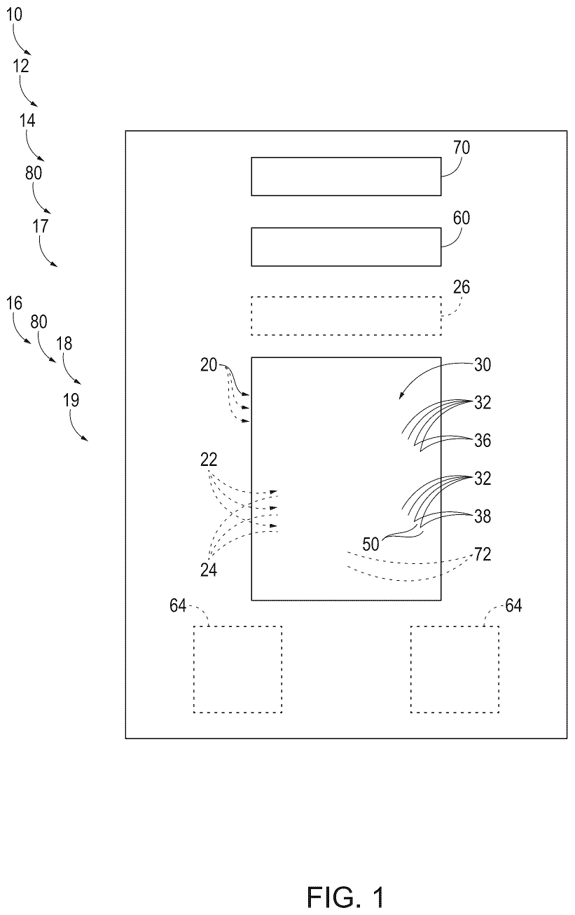

FIGS. 1-15 provide examples of systems 10, stories 20, books 80, and/or methods 100, according to the present disclosure. Elements that serve a similar, or at least substantially similar, purpose are labeled with like numbers in each of FIGS. 1-15, and these elements may not be discussed in detail herein with reference to each of FIGS. 1-15. Similarly, all elements may not be labeled in each of FIGS. 1-15, but reference numerals associated therewith may be utilized herein for consistency. Elements, components, and/or features that are discussed herein with reference to one or more of FIGS. 1-15 may be included in and/or utilized with any of FIGS. 1-15 without departing from the scope of the present disclosure. In general, elements that are likely to be included in a particular embodiment are illustrated in solid lines, while elements that may be optional are illustrated in dashed lines. However, elements that are shown in solid lines may not be essential to all embodiments and, in some embodiments, may be omitted without departing from the scope of the present disclosure.

As used herein, a “grapheme” is the smallest meaningful contrastive unit, such as a letter or digraph, of a writing system. Graphemes are units of writing corresponding to a single sound, which represent or correspond to a phoneme (the corresponding sound). A grapheme thus may be referred to as being a written form of a sound, or phoneme. In the English language, there are between 40 and 47 commonly accepted phonemes.

As used herein, a “decodable” word is a word that consists of graphemes and thus can be sounded out, or decoded, by a reader using the reader's individual decoding skills, such as to analyze the graphemes and/or sound out the corresponding phonemes in the word.

As used herein, a “non-decodable word” refers to a word that cannot be sounded out or decoded by a particular reader using the reader's decoding skills. Many non-decodable words are irregular because they do not follow regular spelling patterns or rules of phonics that typically are taught to students. Examples of such irregular words include “said,” “the,” “tongue,” “soldier,” “enough,” “whom,” “fillet,” “laugh,” and “sign.” Other words cannot be decoded by a particular reader due to the length and irregular syllable breaks of the word.

As used herein, a “sight word” refers to a word that a reader has memorized and can quickly recognize without sounding out the word. For beginning and intermediate readers, sight words typically are shorter words and/or words that occur more frequently than other words in reading passages constructed at the readers' reading level. Examples of sight words include “a,” “I,” “or,” “and,” “old,” “out,” and “the.” Sight words additionally or alternatively may be referred to as high frequency words, star words, heart words, core words, flash words, and/or popcorn words, especially in resources for teaching beginning and intermediate readers to read and/or improve their reading skills. Examples of recognized lists of sight words include Dolch sight words, Fry sight words, and CPB sight words. As a reader improves the reader's reading skills, the number of sight words that are recognized by a reader will increase. As examples, a reader at a third grade reading level may recognize approximately 300 sight words, such as 250-350 sight words, while a reader at a fourth grade reading level may recognize approximately 400-500 sight words.

Some sight words are decodable words that may be sounded out, or decoded, by the reader analyzing the graphemes in the word. However, due to their frequency of occurrence, a reader may memorize and/or recognize the word, such as through a process called orthographic mapping, and thus the reader no longer needs to decode the word. Some other sight words are non-decodable words, at least at the reader's reading level, and thus simply must be memorized by the reader.

As used herein, a “non-decodable, non-sight word” or an “NDNS word” refers to a word that, for a particular reader and/or for a particular reading level, is both not a decodable word and not a sight word. Such words often are more complex and/or less frequently used words.

As used herein, a “grade” refers to a specific year or level of elementary school education. As examples, in the U.S., elementary school education typically begins with preschool, then proceeds to kindergarten, and then 1^{st} through 8^{th} grades, with preschool typically including children who are 4-5 years old, kindergarten typically including children who are 5-6 years old, first grade typically including children who are 6-7 years old, etc.

As used herein, a “reading level” refers to a story's, book's, or other text passage's reading difficulty, such as by considering such factors as sentence and word length, sentence complexity, word difficulty, and assumed phonics skills knowledge. Reading levels may be preselected based on a reader's age, school grade, vocabulary, fluency, comprehension, phonics skills, etc. Examples include grades, or years, of education, such as first, second, third, fourth, fifth, sixth, seventh, and/or eight grade reading levels and/or 6, 7, 8, 9, 10, 11, 12, 13, and 14 years of age reading levels. Additionally or alternatively, a reading level may be defined by industry standards of a reader's vocabulary, phonics skills, and the like. Examples of such industry standards include Lexile (L) scores or Developmental Reading assessment (“DRA”) levels. As illustrative reading levels according to these standards include, a second grade reading level may be 107L to 545L and/or DRA level 18 to DRA level 30, a third grade reading level may be 520L to 820L and/or DRA level 30 to DRA level 38, a fourth grade reading level may be 740L to 940L and/or DRA level 38 to DRA level 40, and a fifth grade reading level may be 750L to 950L, and/or DRL level 50.

Reading levels may vary over time, may differ geographically, may differ based on the language being utilized, etc.; however, incrementally higher reading levels assume a greater knowledge of phonics skills, vocabulary, fluency, and the like than an incrementally lower reading level. Categorization of the words as sight words, decodable words, non-decodable words, and/or NDNS words may correspond to, or be determined based on, a preselected reading level, or range of reading levels. As an example, an NDNS word at a given reading level may be a sight word or a decodable word at a higher reading level, and a decodable word at a given reading level may be a sight word at a higher reading level and an NDNS word at a lower reading level.

As used herein, an “intermediate reader” refers to a reader who is reading, or is expected to be reading, passages that are constructed to be at least at a second grade reading level. Similarly, an “intermediate reading level” refers to at least a second grade reading level. As used herein, a “beginning reader” refers to a reader who is reading at lower than a second grade reading level, and an “experienced reader” refers to a reader who is reading at greater than an eighth grade reading level. Correspondingly, an intermediate reading level includes one or more of a second grade reading level, a third grade reading level, a fourth grade reading level, a fifth grade reading level, a sixth grade reading level, a seventh grade reading level, and an eighth grade reading level, and a beginning reading level includes a reading level that is lower than a second grade reading level. Some intermediate readers also are and/or may be referred to as struggling readers, with such term used herein to refer to intermediate readers who are not able to, or are struggling to, read at a preselected reading level that is considered to be appropriate, such as based on the reader's age, grade, and/or reading experience.

Schematically illustrated in FIG. 1 are examples of systems 10 for developing and/or encouraging intermediate reading according to the present disclosure. As discussed in more detail herein, systems 10 are constructed to present a story 20 that includes discrete pronunciation keys, or guides, immediately adjacent non-decodable, non-sight words such that a reader may utilize the pronunciation keys while reading the passage and without having to interrupt reading to locate a pronunciation key for the word elsewhere in the system, such as in a glossary, or to get assistance with reading and/or pronouncing the word from an outside source, such as a dictionary, the internet, and/or a more experienced reader. Systems 10 additionally or alternatively may be referred to as being constructed to improve, facilitate, encourage, and/or simplify intermediate reading. Intermediate reading also may be referred to herein as reading by intermediate readers, reading of intermediate reading level passages, and/or reading by readers reading at an intermediate reading level.

Story 20 is constructed to be read by a reader and may describe a central, or common, topic or subject. In some examples, a story 20 may discuss a single subject or topic. Story 20 may be fiction, non-fiction, or a combination of both fiction and non-fiction components. Story 20 may have a narrative format and/or be described as being a narrative story, in that the story is designed to be read sequentially from its beginning to its end. Story 20 may be divided into a plurality of chapters 22, each of which contains a subset of the story and thus of the plurality of words of the story. When present, each chapter 22 may have a number, a heading, or a title, 24. Systems 10 that include a story 20 with a plurality of chapters also may include a table of contents 26 and also may be embodied, fixed, included, and/or contained in a book 80. When present, table of contents 26 typically will precede the first chapter 22 of the story and may include entries corresponding to the plurality of chapters, such as a corresponding sequential numbering of the chapters and/or the headings or titles of the chapters. Story 20 additionally or alternatively may be referred to herein as a passage 20, a text passage 20, a narrative passage 20, and/or a prose passage 20.

Story 20 may be at a preselected reading level, such as by being constructed to be at a preselected reading level, in which the story is designed to be read by readers who are at, or who are striving and/or struggling to be at, the preselected reading level. Particular preselected reading levels may be selected or defined based on levels or degrees of knowledge of decoding skills, proficiency with using decoding skills, and knowledge of sight words. Such levels may include specific lists of sight words that are assumed to be known at that reading level and specific decoding skills that the reader is assumed to have proficiency with at the reading level. Examples of preselected reading levels include an intermediate reading level, a non-beginner reading level, a second grade reading level, a third grade reading level, a fourth grade reading level, a fifth grade reading level, a sixth grade reading level, a seventh grade reading level, an eighth grade reading level, at least a second grade reading level, at least a third grade reading level, at least a fourth grade reading level, at least a fifth grade reading level, at least a sixth grade reading level, at least a seventh grade reading level, at least an eighth grade reading level, at most a tenth grade reading level, at most a ninth grade reading level, at most an eighth grade reading level, at most a seventh grade reading level, and/or at most a sixth grade reading level. Additional examples of the preselected reading level include a range of reading levels, such as the second and third grade reading levels, the second through fourth grade reading levels, the third and fourth grade reading levels, the third through fifth grade reading levels, the fourth and fifth grade reading levels, the fourth through sixth grade reading levels, the fifth and sixth grade reading levels, the fifth through seventh grade reading levels, the sixth and seventh grade reading levels, the sixth through eighth grade reading levels, or the seventh and eighth grade reading levels. Story 20 may be constructed to be at, or maintain, the same reading level for at least a substantial portion of the story, which may include the entire story, as opposed to having alternating passages or chapters at different reading levels.

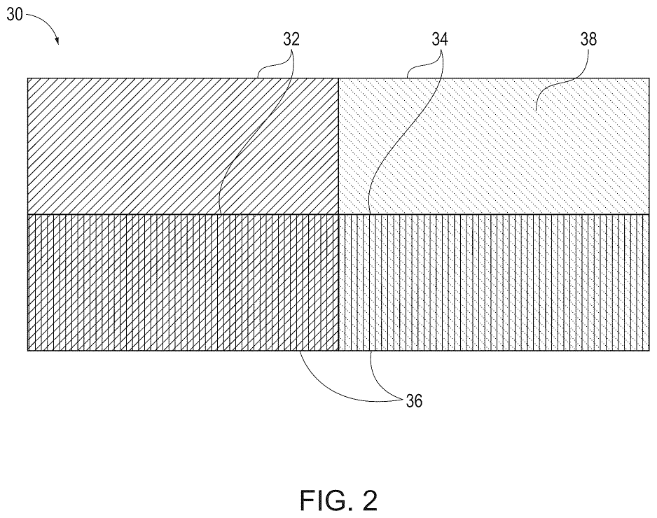

Story 20 comprises a plurality of words 30. The plurality of words 30 includes a plurality of decodable words 32 and a plurality of non-decodable words 34. Some of the decodable and non-decodable words are sight words 36. However, some of the non-decodable words are not sight words and thus may be referred to as non-decodable, non-sight words 38, which may be referred to herein as “NDNS” words. This categorization of words 30 is schematically illustrated in FIG. 2, where decodable and non-decodable words are indicated in boxes 32 and 34, respectively. Overlapping with these boxes is a box 36 that designates sight words 36, with the regions of overlap respectively indicating decodable sight words 32 and NDNS words 38. As discussed herein, NDNS words 38 are based on the preselected reading level of the story, as NDNS words for an intermediate reading level at a particular reading level may not be NDNS words for an intermediate reader at a higher reading level.

Returning to FIG. 1, for all, or at least a substantial portion of, NDNS words 38, story 20 includes a discrete pronunciation key, or “DPK,” 50 that is immediately adjacent at least an initial appearance of each corresponding NDNS word 38. Each DPK 50 provides a guide for teaching the reader how to read and/or pronounce a corresponding NDNS word. For example, DPK 50 may include written phonetic keys for each sound in the NDNS word. DPK 50 may include dashes between syllables, such as to show the reader syllable breaks, and DPK 50 may include a visual indication for emphasized syllables, for example by having emphasized syllables in a more prominent format, such as bold, larger, and/or capital letters, to show the reader which syllable to emphasize. As a particular example, a DPK 50 for the word “chameleon” may be “kuh-MEE-lee-un.” As the reader gains familiarity with the NDNS word, the reader will be able to read the NDNS word with less time, and eventually no time, spent studying the corresponding DPK. The DPKs 50 may be based on a specific letter and/or letter combinations that represent or correspond to specific sounds. DPK 50 additionally or alternatively may be referred to as an individual pronunciation key 50, a phonetic key 50, an individual pronunciation guide 50, and/or a discrete pronunciation guide 50. NDNS words 38 in a story 20 that include a DPK 50 may be referred to herein as NDNS story words, DPK words, DPK NDNS words, keyed NDNS words, and/or guided NDNS words.

Because the reader is an intermediate reader, the reader already should know (i.e., recognize and be able to say and read) the sight words present in the story at the preselected reading level, and the reader should know sufficient phonics skills to decode the decodable words in the story. Thus, by including the DPKs for at least a substantial portion of the NDNS words, the reader should be able to read most, if not all, of the words in the story. Moreover, by presenting the DPKs in close proximity to, or immediately adjacent to, the corresponding NDNS words, the reader is able to read and/or pronounce the NDNS word without interrupting the reader's reading of the story. When reading aloud, the reader thus may be able to continue reading the story without others knowing that the reader does not know the NDNS word, or how to pronounce it. Even when reading silently, the reader is able to read the NDNS word without interrupting the reader's reading of the story, without requiring the reader to transition away from and then back to the story, etc. This contrasts with books that include only a glossary and/or a separate pronunciation guide for challenging words in the book and thus which require the reader to interrupt the reader's reading of the story, flip or otherwise transition to the glossary or pronunciation guide to learn to read and/or pronounce the word, return to the portion of the story containing the NDNS word, and then resume reading the story.

A further benefit of system 10 including DPKs 50 immediately adjacent at least a substantial portion of the NDNS words 38 in story 20 is that system 10 may contribute to increased comprehension of text and increased reading vocabulary of the reader. In this context, developing readers, such as intermediate readers, have a verbal, spoken, or auditory vocabulary that is often much larger than their reading vocabulary. For example, a reader may know the spoken word “Georgia,” but this word may not be in the reader's reading vocabulary. If the reader comes across this difficult word in text, the reader may not be able to read the word, despite the word being in the reader's verbal vocabulary, resulting in a decrease in the reader's comprehension of the text. By including DPKs 50 immediately adjacent NDNS words 38 in the story, the DPKs may allow the reader to read, decode, and pronounce the written form of NDNS words that are in the reader's verbal vocabulary but not the reader's reading vocabulary, thus increasing comprehension of the text and helping to increase the reader's reading vocabulary.

By “initial appearance,” it is meant an initial presentation or initial occurrence of the NDNS word in the story. The initial appearance may be or include the first appearance of the NDNS word in the story, the first two appearances of the NDNS word in the story, or at least the first two appearances of the NDNS word in the story. It is within the scope of the present disclosure that story 20 may include a DPK 50 for each NDNS word in the story and/or that the story may include a DPK 50 for each occurrence of an NDNS word in the story. The story also may include a DPK 50 for some or all occurrences of the corresponding NDNS word in a title, table of contents, introduction or instructional guide, and/or header (if/as present) of the system and/or story.

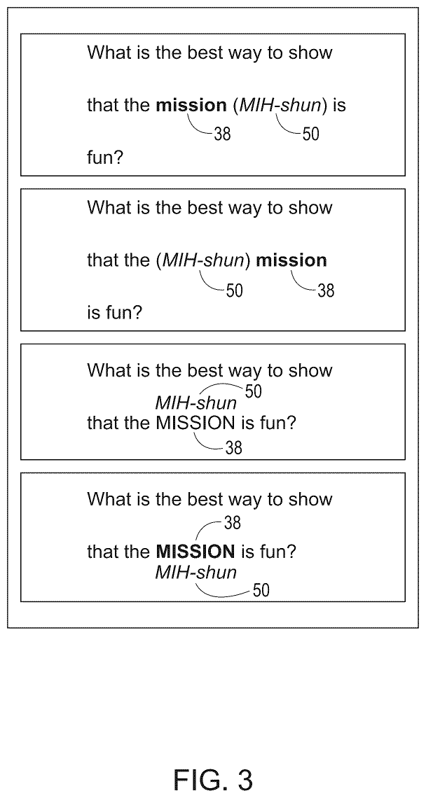

By “immediately adjacent,” it is meant that DPK 50 is presented sufficiently close to the corresponding NDNS word that the reader may read the DPK immediately before or after reading the NDNS word and without needing to move the reader's eyes to a separate portion of the system that is distinct from the story, such as a margin, footer, or header of the page or screen on which the story is presented to the reader, a master glossary before or after the story, etc. Examples of immediately adjacent presentations of a DPK 50 relative to an NDNS word 38 include the DPK being immediately before the NDNS word (i.e., between the NDNS word and the preceding word in the story), immediately after the NDNS word (i.e., between the NDNS word and the next word in the story), or closely spaced above or below the NDNS word (i.e., in space that otherwise would not contain lines of text of the story and/or are between adjacent lines of text of the story). DPK 50 additionally or alternatively may be described as being in-line with the words of the story. As indicated above, a story 20 according to the present disclosure will not include a DPK for most, or even any, of the decodable words or the sight words of the plurality of words 30. Instead, DPK 50 only may be presented in story 20 for at least a substantial portion of, and potentially all of, the NDNS words. FIG. 3 schematically illustrates examples of immediately adjacent positions of DPK 50 relative to the NDNS word “mission.”

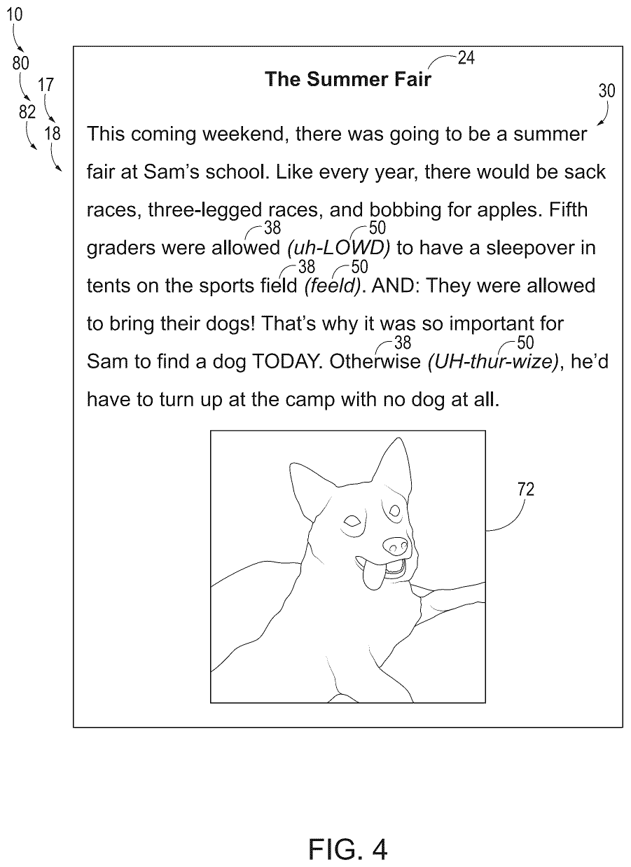

As discussed, DPK 50 is intentionally positioned, or presented, immediately adjacent the corresponding NDNS word 38. DPK 50 also may be visually set apart, or distinguished, from the corresponding NDNS word so that the DPK has a different visual appearance than the NDNS word or even than all of the words in the story. As examples of ways to visually set apart a DPK from the corresponding NDNS word, the DPK may be bounded by parentheses, presented in a different size (i.e., a larger or a smaller size), presented in a different font, presented in a different color (i.e., a lighter or darker color), presented with different capitalization, presented with a different hue (i.e., gray-scale, lighter, or bold vs a standard presentation of the NDNS word), and/or presented in a different font style (i.e., italics or underline vs no italics or no underline). A further example is to present the DPK in a rectangle or other surrounding shape, or perimeter. FIG. 3 also provides examples of how a DPK 50 may be visually set apart from the corresponding NDNS word. FIG. 4 provides an example of a page of a system 10 embodied in a book 80 (such as a printed book 17 or an e-book 18) that includes a subset of the plurality of words 30 of story 20, with NDNS words 38 immediately adjacent DPKs 50. FIG. 4 also illustrates an example of a portion of a system 10 that includes a heading or title 24 for a chapter 22 of the book, and an illustration 72 that corresponds to the portion of the story.

As discussed, story 20 is constructed (i.e., drafted, created, selected, and/or designed) to be at a preselected reading level at which the words in the story should be able to be read by a reader who is reading at or above the preselected reading level. The number of words 30 in story 20 may vary depending on the preselected reading level, such as with higher reading level stories having more words than lower reading level stories. However, story 20 is constructed to be read by an intermediate reader and thus generally will have more words than conventional beginning reading books, such as by having at least 750 words. As specific examples, it is common for a conventional story having a second grade preselected reading level to contain 500-1,000 words, for a conventional story having a third grade preselected reading level to contain 1,500-5,000 words, and for a conventional story having a fourth grade preselected reading level to contain 4,000-10,000 or more words. As more specific examples, the plurality of words 30 may have, or be comprised of, at least 500 words, at least 800 words, at least 1,000 words, at least 1,500 words, at least 2,000 words, at least 2,500 words, at least 3,000 words, at least 4,000 words, at least 5,000 words, at least 6,000 words, at least 7,000 words, at least 8,000 words, at least 10,000 words, at least 15,000 words, at most 20,000 words, at most 12,000 words, at most 10,000 words, at most 8,000 words, at most 7,500 words, at most 6,000 words, and/or at most 5,000 words. As still more examples, the plurality of words 30 in a story 20 may be comprised of 1,500-5,000 words, 2,000-6,000 words, 2,500-7,500 words, 3,000-8,000 words, or 4,000-15,000 words. Story 20 additionally or alternatively may be described as containing, or being comprised of, any of the above examples of words in the plurality of words 30.

As discussed, the plurality of words 30 includes decodable words 32, sight words 36, and NDNS words 38. As also discussed, the categorization of these words may vary based on the preselected reading level of a particular story 20 that contains the plurality of words. The number of such words 30 in story 20 may vary, but story 20 typically will include fewer NDNS words than decodable words, sight words, and/or the total of decodable words and sight words, including less than 30%, less than 25%, less than 20%, less than 15%, less than 10%, less than 5%, at least 1.5%, at least 5%, at least 10%, at least 15%, at least 20%, and/or at least 25% of the number of decodable words, the number of sight words, or the number of decodable words and non-decodable sight words. Expressed in other words, story 20 may include fewer NDNS words than decodable words or sight words. For example, story 20 may include less than 30%, less than 25%, less than 20%, less than 15%, less than 10%, at least 5%, at least 10%, at least 15%, at least 20%, and/or at least 25% of the number of decodable words, the number of sight words, or the number of decodable words and non-decodable sight words.

Story 20 may include the same or fewer number of DPKs 50 as the number of NDNS words 38. In some stories 20, the number of DPKs 50 may be at most 20%, at most 15%, at most 12%, at most 10%, at most 8%, at most 6%, at most 4%, at least 1.5%, at least 2%, at least 3%, at least 4%, at least 5%, at least 6%, at least 7%, at least 8%, and/or at least 10% of the plurality of words 30 in story 20. When story 20 is divided into pages, such as pages of printed text, the number of DPKs 50 on a page may be limited to be no more than a predetermined maximum number, such as 10, 8, 6, 5, 4, 3, 2, less than 25% of the number of words on the page, less than 20% of the number of words on the page, less than 15% of the number of words on the page, less than 10% of the number of words on the page, and/or less than 5% of the number of words on the page.

Story 20 may include at least 100 sight words, at least 150 sight words, at least 200 sight words, at least 250 sight words, at least 300 sight words, at least 400 sight words, at least 500 sight words, at least 600 sight words, at least 750 sight words, at least 1,000 sight words, at least 2,000 sight words, at most 2,500 sight words, at most 1,200 sight words, at most 1,000 sight words, at most 800 sight words, at most 750 sight words, at most 600 sight words, at most 500 sight words, at most 400 sight words, and/or at most 300 sight words. At least a substantial portion of the sight words in the plurality of words may be contained in standardized lists of sight words, including one or more of the Dolch sight word list, the Fry sight word list, and the CPB sight word list.

For a preselected reading level, the plurality of words 30 in a story 20 may include more decodable words 32 than sight words and/or non-decodable sight words. For example, story 20 may include at least 250 decodable words, at least 500 decodable words, at least 1,000 decodable words, at least 1,500 decodable words, at least 2,000 decodable words, at least 2,500 decodable words, at least 3,000 decodable words, at least 4,000 decodable words, at least 5,000 decodable words, at least 6,000 decodable words, at least 7,500 decodable words, at least 10,000 decodable words, at most 12,000 decodable words, at most 10,000 decodable words, at most 8,000 decodable words, at most 7,500 decodable words, at most 6,000 decodable words, at most 5,000 decodable words, at most 4,000 decodable words, and/or at most 3,000 decodable words. In other examples, the plurality of words may include at least 4 times, at least 5 times, at least 6 times, at least 7 times, at least 8 times, at least 9 times, at least 10 times more decodable words in the plurality of decodable words than sight words in the plurality of sight words. As still other examples, the plurality of decodable words may be at least 35%, at least 40%, at least 45%, at least 50%, at least 60%, at least 70%, at least 75%, at least 80%, at most 90%, at most 85%, at most 80%, at most 75%, at most 70%, at most 65%, at most 60%, and/or at most 50% of the plurality of words in story 20.

The plurality of words 30 may contain a different number of NDNS words 38 than the number of sight words 36 in the plurality of words. For example, the plurality of words 30 may include a greater number of NDNS words 38 than the number of sight words 36 or a lower number of NDNS words 38 than the number of sight words 36. Expressed differently, the plurality of words 30 may include at least 50 NDNS words, at least 60 NDNS words, at least 75 NDNS words, at least 100 NDNS words, at least 150 NDNS words, at least 200 NDNS words, at least 250 NDNS words, at least 300 NDNS words, at least 500 NDNS words, at least 1,000 NDNS words, at least 2,000 NDNS words, at most 4,000 NDNS words, at most 2,000 NDNS words, at most 1,000 NDNS words, at most 800 NDNS words, at most 750 NDNS words, at most 600 NDNS words and/or at most 500 NDNS words. As another example, the plurality of NDNS words 38 may be at least 2%, at least 3%, at least 4%, at least 5%, at least 7.5%, at least 10%, at least 12.5%, at least 15%, at least 20%, at most 40%, at most 30%, at most 25%, at most 20%, at most 17.5%, at most 15%, at most 12.5%, at most 10%, and/or at most 5% of the plurality of words 30.

As used herein, references to the number of words (including words 30, decodable words 32, non-decodable words 34, sight words 36, and NDNS words 38) refer to the total number of such words, including repetitions thereof. Within the scope of the present disclosure, references to a number of discrete words (including words 30, decodable words 32, non-decodable words 34, sight words 36, and NDNS words 38) may be used to refer to the total number of unique, or non-repeated number, of such words in the story. The number of such discrete words may be the same as the total number of such words, although it often will be less, such as being at most 90%, at most 80%, at most 75%, at most 70%, at most 60%, at most 50%, at least 10%, at least 12%, at least 25%, at least 30%, and/or at least 40% of the corresponding total number of such words.

Returning to the schematic examples of FIG. 1, system 10 is embodied in a medium 12, such as a print medium 14 or an electronic medium 16, on/from which story 20 is visibly presented, or displayed, to a reader. An example of print medium 14 is a printed book 17. Examples of electronic media 16 include an electronic book (“e-book”) 18 and a webpage or a website 19 from which the story is displayed to or otherwise accessed by a reader. When system 10 is embodied in, or as, a book 17, 18 that includes chapters, the book may be referred to as a children's chapter book.

System 10 may include additional elements beyond those described above. Examples include one or more of a description 60 of how to utilize the DPKs to read the story, a master pronunciation key 62, and a list of phonetic elements 64 contained in the plurality of words 30, a reading level indicia 70, and/or illustrations 72.

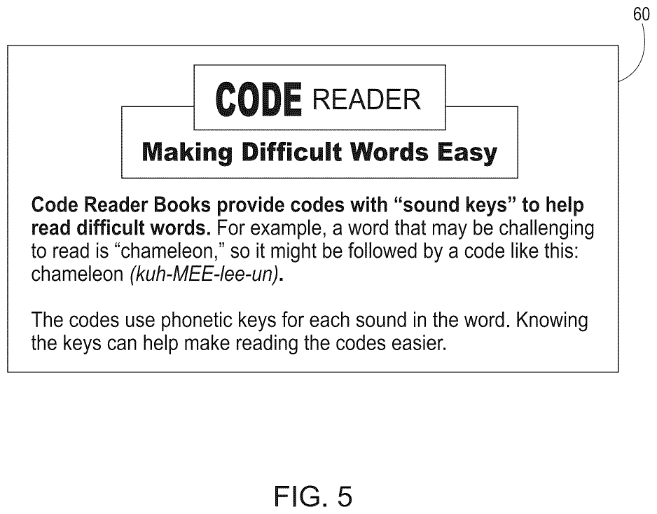

Description 60 presents to the reader an explanation about how to read story 20, including a discussion of how to utilize the plurality of DPKs 50 to learn how to pronounce and/or read the NDNS words 38 in the story. Description 60 additionally or alternatively may be referred to as an introduction 60, a usage guide 60, a how-to guide 60, and/or instructions 60. An example of description 60 is presented in FIG. 5.

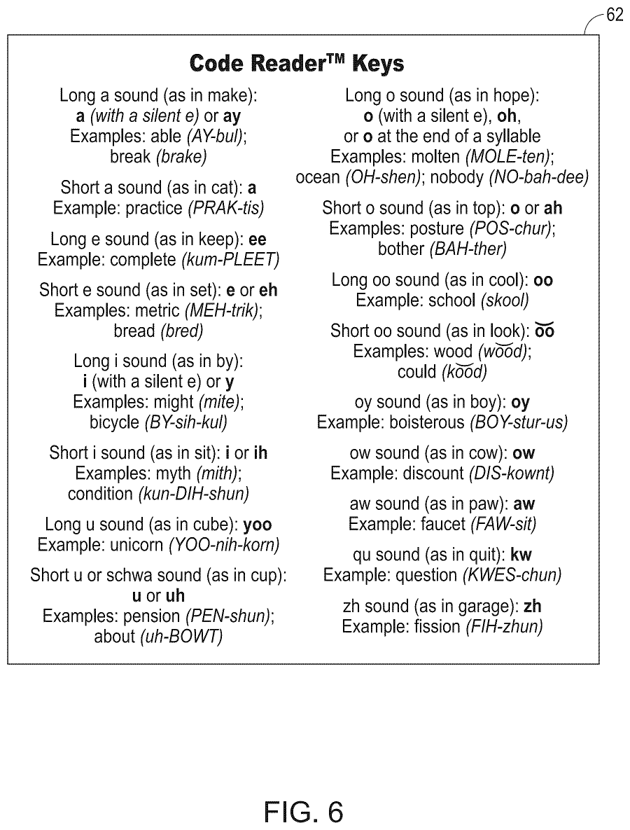

Master pronunciation key 62 may contain a list of at least a substantial portion of the phonetic elements, or phonetic keys, used in the story for at least a substantial portion of the phonetic sounds and presentations used in DPKs 50. Some master pronunciation keys 62 may include a list of at least a substantial portion of the phonetic elements used in the story for at least a substantial portion of the vowel sounds used in DPKs 50. Some master pronunciation keys 62 may include a list of at least a substantial portion of the phonetic elements used in the story for at least a substantial portion of the vowel and consonant sounds used in DPKs 50. An example of a master pronunciation key 62 is presented in FIG. 6. In this example, the master pronunciation key emphasizes vowel sounds.

List 64 of phonetic elements contains a listing of at least a substantial portion of the graphemes and/or phonemes contained in the decodable words 32 of the plurality of words 30, and list 64 further may include pronunciation keys for each of the phonetic elements. Such a list 64 may include a division of graphemes, suffixes, and prefixes for different reading levels, showing the ones that are assumed to be known by a reader at a particular preselected reading level and that the reader can practice while reading the text of the story. By showing the phonetic elements that should be known for a particular preselected reading level, it may be easier for educators and readers to identify the reading levels of stories in the system that are appropriate for a particular reader. List 64 additionally or alternatively may be referred to as a reading level chart 64, a reading level guide 64, a table 64 of phonetic elements by reading level, a phonetic element by reading level chart 64, and/or a reading level selection tool 64.

Examples of lists 64 are presented below, with the examples further illustrating suitable lists for three representative preselected, or predefined, reading levels. In the following examples, purple, green and blue reading levels are included, with the green reading level being more advanced, or higher, than the purple reading level and being less advanced, or lower, than the blue reading level, and with such reading levels optionally referred to as first, second, and third reading levels. In such examples, the purple reading level corresponds to an intermediate reading level in which the reader has knowledge and familiarity with approximately 300 high-frequency words, such as at least a substantial portion of the 220 Dolch words and at least a substantial portion of the first 300 Fry words. In such examples, the green reading level corresponds to an intermediate reading level in which the reader has knowledge and familiarity with approximately 400 high-frequency words, including all 220 Dolch words and at least a substantial portion of the first 400 Fry words. In such examples, the blue reading level corresponds to an intermediate reading level in which the reader has knowledge and familiarity with all 220 Dolch words, Fry words 1-300, and at least a substantial portion of Fry words 401-700. Readers at the green reading level also may have knowledge and familiarity with some of the CPB sight/high frequency words, and a reader at the blue reading level may have knowledge and familiarity with more of the CPB sight/high frequency words than a reader at the green reading level. The purple reading level may correspond to a first, second, or third grade reading level, the green reading level may correspond to a second, third, or fourth grade reading level, and the blue reading level may correspond to a third, fourth, or fifth grade reading level.

| | PURPLE | GREEN | BLUE | |
|---|---|---|---|---|
| | Assumes | Assumes | Assumes knowledge | Graphemes NOT |
| | knowledge of | knowledge of | of Purple and | assumed to be |
| | these | Purple, plus | Green, plus these | known for Purple, |
| Phoneme | graphemes | these graphemes | graphemes | Green, or Blue |
| /ā/ | ay (bay) | a (apron) | eigh (eight) | er (foyer) |
| | ai (wait) | | aigh (straight) | et (filet) |
| | a_e (came) | | | au (gauge) |
| | | | | ea (break) |
| | | | | ey (prey, obey) |
| | | | | ei (rein) |
| /ē/ | y (silly) | ey (monkey) | ie (chief) | oe (phoenix) |
| | ee (see) | | ei (either) | eo (people) |
| | ea (seat) | | i (ski, audio) | ae (algae) |
| | e_e (these) | | | |
| | e (me) | | | |
| /ī/ | i_e (fire) | i (idea) | y_e (byte, type) | ai (aisle) |
| | y (try) | igh (night) | | is (island) |
| | ie (pie) | ye (bye) | | ei (heist) |
| | | | | eye (eyebrow) |
| | | | | eigh (height) |
| | | | | oi (choir) |
| /ō/ | o_e (vote) | ow (throw) | ou (soul) | eau (bureau) |
| | oa (coat) | o (cold; potion) | ough (though) | ew (sew) |
| | oe (toe) | | | |
| /y-ū/ | u_e (cube) | ue (argue) | eau (beauty) | eu (feud) |
| | | ew (few) | u (music) | |
| /ĕ/ | a (cat) | | | ai (plaid) |
| | | | | au (laugh) |
| /ĕ/ | e (bed) | a (many; any) | ie (friend) | eo (leopard) |
| | | | ai (said) | ei (heifer) |
| | | | ea (bread) | ae (aerate; |
| | | | | aesthetic) |
| | | | | ay (says) |
| /ĭ/ | i (sit) | | y (myth) | u (busy) |
| | | | | ui (build) |
| | | | | ie (sieve) |
| | | | | o (women) |
| | | | | ee (breeches) |
| | | | | ei (counterfeit) |
| | | | | a_e (storage; |
| | | | | private) |
| /ŏ/ | o (rot) | a (swap) | al (talk) | al (palm) |
| | ah (ah) added | | also in aw | ho (honest) |
| | as | | augh (caught) | a (swan) |
| | a sight word | | also in aw | oa (broad) |
| | | | ough or ou (cough) | also in aw |
| | | | also in aw | |
| | | | au (fraud) | |
| | | | also in aw | |
| | | | aw (saw) | |
| | | | also in aw | |
| /ŭ/ + | u (rug) | “uh” schwa | | o (won) |
| “uh” | | (comma, about, | | oo (blood) |
| schwa | | sofa) | | ou (touch; nervous) |
| | | e (item) | | ai (curtain) |
| | | i (pencil) | | ei (foreign) |
| | | | | ia (parliament) |
| | | | | ea (ocean) |
| | | | | oi (porpoise) |
| | | | | y (vinyl) |
| /oo/ (as | oo (hook) | | ou (would) | o (woman) |
| in took) | | | u (pudding; push, | |
| | | | bull) | |
| /ōō/_(as | oo (moon) | ue (blue) | ough (through) | ui (suit) |
| in soon) | u_e (tube) | ew (new) | ou (soup) | eu (feud |
| | | u (super) | eau (beautiful | also in yoo) |
| | | | also in yoo) | o (whom) |
| | | | | oe (canoe) |
| | | | | ough (through) |
| | | | | ieu (milieu) |
| /oi/ (as in | oy (boy) | | | ouy (bouy) |
| soil) | oi (soil) | | | |
| /ow/ (as | ow (now) | ou (out) | | ough (drought) |
| in how) | | | | |
| /aw/ (as | aw (saw) | al (talk; walk) | ough (bought) | oa (broad) |
| in law) | all (call) | | au (fraud) | |
| | | | augh (taught) | |
| | | | a (watch) | |
| /u(r)/ | er (herd) | ar (collar) | ear (learn) | yr (syrup) |
| | ir (girl) | or (worst, history) | our (journey) | eur (chauffeur) |
| | ur (turn) | | | |
| /o(r)/ | or (for) | | our (four) | |
| | ore (sore) | | oor (door) | |
| | oar (roar) | | | |
| /a(r)/ | ar (far) | | | ear (hearth) |
| /ā(r)/ | air (hair) | | ear (pear) | |
| | are (dare) | | ere (where) | |
| | | | eir (their) | |
| | | | er (territory) | |
| /ir/ | eer (deer) | | ier (pier) | |
| | ear (hear) | | | |
| /b/ | b (bed) | | | pb (cupboard; |
| | bb (cobb) | | | raspberry) |
| /d/ | d (dog) | ld (could) | | |
| | ed (played) | | | |
| | dd (hidden) | | | |
| /f/ | f (fan) | | lf (half) | |
| | ff (waffle) | | gh (laugh) | |
| | ph (phone) | | | |
| /g/ | g (girl) | gh (ghost) | | gue (prologue) |
| | gg (struggle) | | | gu (guest; guilty) |
| /h/ | h (hat) | | | wh (whole) |
| /j/ | g (giraffe) | d (procedure) | gg (suggest) | dj (adjoin) |
| | dge (fudge) | | | di (soldier) |
| | j (juice) | | | |
| | ge (cage; | | | |
| | garage) | | | |
| /k/ | c (cat) | cc (soccer) | ch (chord) | que (plaque) |
| | ck (back) | | | kh (khaki) |
| | k (kite) | | | |
| | ck (block) | | | |
| /k-w/ | qu (quiet) | | | |
| /k-s/ | x (fox) | | | |
| /l/ | le (little) | | | |
| | l (led) | | | |
| | ll (fall) | | | |
| /m/ | m (man) | | mb (comb) | mn (autumn) |
| | mm (hammer) | | | lm (palm, salmon) |
| | | | | gm (phlegm) |
| /n/ | n (not) | | gn (gnaw) | pn (pneumonia) |
| | nn (manner) | | | mn (mnemonic) |
| | kn (know) | | | |
| /p/ | p (plan) | | | |
| | pp (stopper) | | | |
| /r/ | r (rat) | | | rh (rhyme; rhubarb) |
| | rr (mirror) | | | |
| | wr (wrap) | | | |
| /s/ | s (sit) | ce (dance) | sc (science) | sw (sword) |
| | ss (floss) | se (dense) | c (cease) | ps (psychology) |
| | | | st (castle) | |
| /t/ | t (top) | | bt (debt) | |
| | tt (hotter) | | | |
| | ed (placed) | | | |
| /v/ | v (van) | | ph (Stephen) | f (roofs) |
| | ve (five) | | | |
| | vv (revving) | | | |
| /w/ | w (water) | | | |
| | wh (when) | | | |
| | (q)u (question) | | | |
| /y/ | y (yes) | | | |
| /z/ | z (zip) | s in the middle of | | x (xylophone) |
| | s (at end of a | a word (as in | | |
| | word) | laser, president, or | | |
| | zz (fuzz) | please) | | |
| | | ze (ooze) | | |
| | | se (browse) | | |
| | | x (exam) | | |
| | | ss (dessert) | | |
| /zh/ | | | | |
| /th/ | th (thumb) | | | |
| unvoiced | | | | |
| /th/ | th (feather) | | | |
| voiced | | | | |
| /ch/ | ch (chop) | | | |
| | tch (hatch) | | | |
| /ng/ | ng (sing) | | | ngue (tongue) |
| /sh/ | sh (shop) | ti (potion) | ch (machine) | ssi (mission; |
| | | | ci (special) | fission) |
| | | | si (vision; fusion) | |
| /wh/ | wh (where) | | | |
| (with | | | | |
| breath) | | | | |

SUFFIXES & INFLECTIONAL ENDINGS

| | | | Suffixes NOT |
|---|---|---|---|
| PURPLE | GREEN | BLUE | assumed to be |
| Includes practice | Adds practice | Adds practice | known for Purple, |
| of these suffixes | of these suffixes | of these suffixes | Green, or Blue |
| -ery (bakery) | -ary (dictionary) | -ium (calcium) | -ious/-eous (precious, |
| -ed (/t/ walked; /d/ | -cide (pesticide) | -ous (poisonous) | righteous) |
| rubbed; | -ence (excellence) | -age (manage) | |
| /ed/ printed) | -ism (patriotism) | -ial (colonial) | |
| -es (places); - | -sure (measure) | -ance (attendance) | |
| -s (bags) | -al (formal, arrival) | -ive/-itive/-ative, if the | |
| -all | -able (capable) | i makes a short i | |
| -er/-or (boxer, | -ant (immigrant) | sound. (festive, active, | |
| survivor) | -tion (invitation) | talkative, [but survive | |
| -ly (friendly) | | is Purple level]) | |
| -ing (talking) | | -ian (librarian) | |
| | | -logy (biology) | |
| | | -sion (vision) | |
| | | -ture (picture) | |

PREFIXES

| | | | Prefixes NOT |
|---|---|---|---|
| PURPLE SERIES | GREEN SERIES | BLUE SERIES | assumed to be |
| Includes practice | Adds practice | Adds practice | known for Purple, |
| of these prefixes | of these prefixes | of these prefixes | Green, or Blue |
| pre- (prefix) | | super- (superstar) | syn- (synonym) |
| re- (return) | | tele- (telephone) | anti- (antitheft) |
| | | de- (debug, deter) | extra- (extraterrestrial) |
| | | bi- (biweekly) | fore- (forecast) |
| | | di- (diameter) | semi- (semicircle) |
| | | co- (copay) | mono- (monologue) |
| | | auto- (automobile) | circum- (circumstance) |
| | | dys- (dystopian) | equi- (equilateral) |
| | | | pseudo- (pseudonym) |
| | | | retro- (retrospective) |

When present, description 60, master pronunciation key 62, and/or phonetic list 64 may be located at any suitable portion of system 10. Examples include before the story, after the story, on a cover of a story contained in a print book, on a page that precedes or follows the pages of a book containing the story, on a web page associated with an electronic implementation of the system, and/or on a pop-up or other screen or display associated with an electronic implementation of the system. As another example, system 10 may include a hyperlink and/or URL via which these elements of the system may be accessed by a reader. As a further example, master pronunciation key 62 and/or phonetic list 64 may be embodied in a separate medium than story 20 and/or the remainder of system 10, such as by being provided in a different, or separate, print medium or being provided or accessible in a different, or separate, electronic medium, examples of which are provided herein.

In some systems 10, it may be desirable for the master pronunciation key 62 and/or list 64 of phonetic elements, when present, to be located after story 20 so that a reader accessing the system from its beginning encounters the story before these other elements. Doing so may avoid intimidating the reader or otherwise deterring the reader from beginning to read the story. Similarly, it may be desirable for description 60 to be located before the story so that the reader knows how to utilize the DPKs in the story and/or is proactively comforted that the reader will be able to read the story despite the story including NDNS words that the reader may not know how to read prior to reading the story.

Reading level indicia 70 corresponds to the preselected reading level (or range of preselected reading levels) of the system's corresponding story 20. Reading level indicia 70 additionally or alternatively may be referred to as a reading level indicator 70. Examples of reading level indicia 70 include one or more of a color, a symbol, a graphic, a pattern, at least one number, at least one letter, and/or a character string. When present, reading level indicia 70 may be presented (i.e., located for viewing by the reader) in a suitable manner and/or location for viewing in advance of, or independent of, the reader accessing the story. For example, reading level indicia 70 may be presented on a front cover, back cover, spine, title, and/or introduction of a system 10 embodied as a print book. As another example, reading level indicia 70 may be presented on the title, file name, download screen, launch page, header, and/or introduction of a system 10 embodied as an e-book, webpage, or website.

System 10 may include a plurality of illustrations 72 that correspond to the story, such as to the subject or topics of the story, events that take place and/or are described in the story, characters of the story, etc. When system 10 includes illustrations 72, the illustrations may be presented concurrent with the plurality of words, such as proximate to passages of the plurality of words, between passages of the plurality of words, etc.

Although described and illustrated primarily as including a single story 20, it is within the scope of the present disclosure that system 10 may include a plurality of stories. At least one of the plurality of stories may be a story 20 according to the present disclosure, and optionally each of the stories in the plurality of stories may be a story 20 according to the present disclosure. When system 10 includes a plurality of stories 20, each of the stories 20 may be at the same preselected reading level. A reader then may select from any of the stories 20 and receive consistent encouragement to improve the reader's reading skills. In some examples, at least one of the stories 20 may be at a different preselected reading level than at least one other of the stories 20. Containing stories 20 at different preselected reading levels may enable system 10 to be utilized by readers having a wider range of reading levels and/or to continue to be used by a reader as the reader's reading level increases. In such examples, each of the stories 20 may include a reading level indicia 70 to designate to the reader the preselected reading level, or range of levels, of the corresponding story 20.

When system 10 is embodied as a book 80 (printed book 17 or e-book 18), it may define a plurality of pages 82, at least a substantial portion of which may include a subset of the plurality of words 30, discrete pronunciation keys 50, and/or other elements of system 10 that are described and/or illustrated herein. The number of pages 82 in book 80 may vary according to such factors as the preselected reading level, the length of the story, the size of the font utilized for the plurality of words, the number of illustrations, etc. As examples, a book that contains a story 20 according to the present disclosure may include at least 40 pages, at least 48 pages, at least 64 pages, at least 80 pages, at least 100 pages, at least 150 pages, at most 500 pages, at most 400 pages, at most 300 pages, at most 200 pages, at most 175 pages, at most 150 pages, at most 125 pages, and/or at most 100 pages. When a book 80 includes a plurality of stories 20, each story 20 may represent any of the above-discussed examples of numbers of pages. Additionally or alternatively, each story 20 may be shorter, with the book containing the plurality of stories containing any of the above-discussed examples of number of pages.

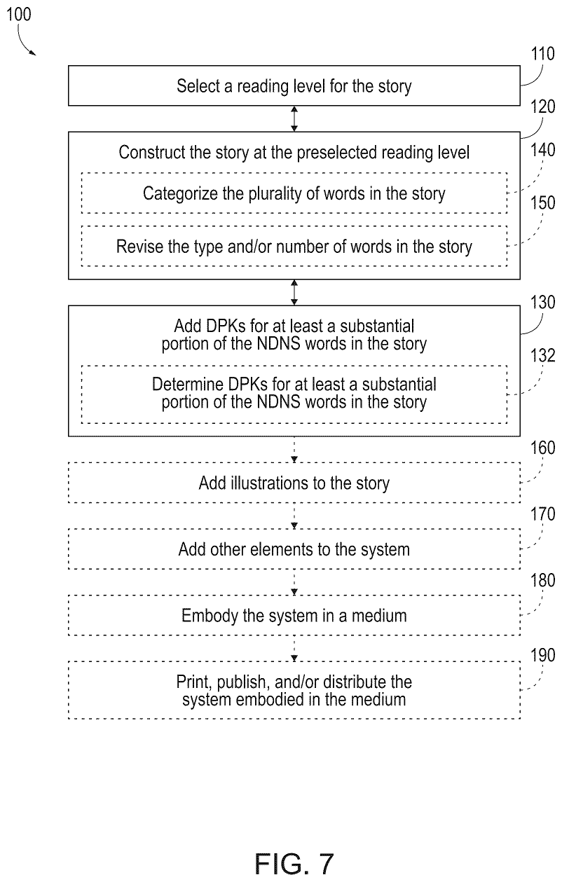

Systems 10, including books 80, according to the present disclosure may be created in any suitable manner without departing from the scope of the present disclosure. Examples of suitable methods 100 for creating systems 10 are illustrated in FIG. 7. As shown, methods 100 include selecting a reading level at 110, constructing a story at the preselected reading level at 120, and adding DPKs for at least a substantial portion of the NDNS words in the story at 130. Methods also may include categorizing the plurality of words in the story at 140, revising the type and/or number of words in the story at 150, adding illustrations to the story at 160, adding other elements to the system at 170, embodying the system in a medium at 180, and printing, publishing, or distributing the system in the embodied medium at 190.

At 110, method 100 includes selecting the reading level for the story. Because system 10 is designed to be read by a reader, such as an intermediate reader at an intermediate reading level, at a reading level for a specific age or range of ages of readers, at a reading level for a reader in a specific grade or range of grades, etc., the reading level for the story should be selected to correspond to the target, or intended, reading level of the reader. The selected reading level thus may be referred to as the preselected reading level for the story, examples of which are disclosed herein.

At 120, the story is constructed, such as at the selected reading level. Examples of suitable stories, including the elements and features thereof, are disclosed and/or illustrated herein with respect to story 20. Constructing the story at 120 may include selecting an existing story, or a portion thereof, creating a story based on an existing story, or creating an original story.

Constructing the story at 120 may include categorizing the plurality of words in the story at 140 and/or revising the type and/or number of words in the story at 150. For example, the number of sight, decodable, non-decodable, and/or NDNS words in the story may be categorized, and as desired or necessary, adjusted to correspond to the preselected reading level.

It also is within the scope of the present disclosure that selecting the reading level for the story may be performed or repeated/adjusted after constructing the story. For example, the story may be constructed and then a reading level is selected, or determined, for the constructed story, such as after categorizing the words in the story. As another example, the story initially may be intended to be at a first preselected reading level, but the constructed story may end up being at, or more appropriately, at a second reading level that is different (i.e., higher or lower) than the first preselected reading level. In such a situation, the selected reaching level for the story may be adjusted to be the second reading level, which in such a situation may be referred to as a second preselected reading level. Additionally or alternatively, a subset of the words in the story may be changed to adjust the reading level of the story, such as to correspond to the first preselected reading level. For example, the number of NDNS words in the story may be increased or decreased, at least one of the NDNS words may be changed to another NDNS words or to a word that is not an NDNS word, etc.

At 130, discrete pronunciation keys, or DPKs, are added to the story for at least a substantial portion, and optionally all, of the NDNS words in the story at least the first time a particular NDNS word appears in the story. DPKs may be added immediately adjacent to the corresponding NDNS words, and examples of DPKs, their positions, and their formats are disclosed and/or illustrated herein with respect to DPKs 50. Concurrent with or after adding the DPKs, methods 100 may include revising the story to adjust the number of DPKs that are presented in the story, or a portion thereof, such as the initial page of the story, the initial chapter of the story, any page of the story, any chapter of the story, etc.

As indicated at 132, method 100 may include determining the DPKs for at least a substantial portion, including all, of the NDNS words in the story. For example, and as discussed, the DPKs may be based on or derived from a master pronunciation key for the story, for the preselected reading level, and/or for the system. DPKs may be determined and formatted in any suitable manner, with examples including using a pronunciation key, such as master pronunciation key 62, lists of phonetic elements, such as lists 64, tables and/or databases of phonetic elements, pronunciations, and/or stored pronunciation keys, computer program products and/or processing logic configured to generate DPKs, etc. As a further example, Arpabet phonetic codes may be used and/or considered. Arpabet phonetic codes were developed in the 1970s for representing English sounds in computers and have been used in connection with computerized speech recognition and speech synthesis. Arpabet uses capital letters and digraphs to map to phonemes.

It is within the scope of the present disclosure that constructing the story at 120 may include categorizing the plurality of words in the story at 140. Categorizing the words in the story includes considering at least the number of NDNS words in the story for a preselected reading level. For example, this may include selecting or identifying words that are challenging to be read (i.e., by sight and/or decoding) by a reader at a selected reading level. Such challenging words may be NDNS words 38 for the reading level. Categorizing at 140 also may include considering the number of sight and/or decodable words at the preselected reading level.

Methods 100 further may include revising the type and/or number of words in the story at 150, such as to conform the story to a preselected reading level, to adjust the preselected reading level of the story, and/or to adjust the number, reading level, and/or frequency of the NDNS words in the story. Such a version of methods 100 additionally or alternatively may be referred to as, or as including, selecting or identifying words that are challenging to be read (i.e., by sight and/or decoding) by a reader at a selected reading level and then adding DPKs for at least a substantial portion of such words. Such challenging words may be NDNS words 38 for the preselected reading level.

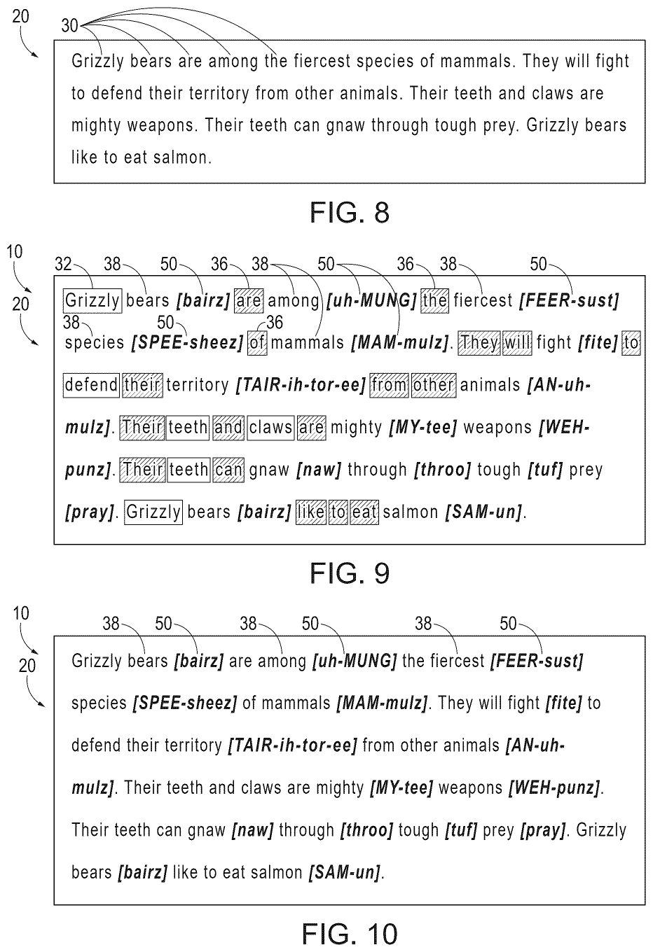

To illustrate examples of the constructing at 120 and the adding at 130, consider the story 20 shown in FIG. 8. Story 20 includes a variety of words 30, including words that may be sight words, decodable words, non-decodable words, and NDNS words at a selected reading level. FIG. 9 provides an example of story 20 after being categorized at 140 and after the addition of DPKs 30 for the NDNS words 38. As shown in FIG. 9, the categorizing at 140 may include designating, or differentiating, the words in the story as decodable words 32 (surrounded by an unshaded box, or surrounding perimeter, in FIG. 9), sight words 36 (surrounded by a shaded box, or shaded surrounding perimeter, in FIG. 9), and NDNS words 38 (presented with immediately adjacent DPKs 50 in FIG. 9). The categorizing at 140 may be based on the preselected reading level for the story and/or of the intended reader of the story. The adjusting at 150 may be based at least in part on the number of decodable words 32, sight words 36, and/or NDNS words 38 in the story. For example, a decodable word at one reading level may be a sight word at a higher reading level and/or an NDNS word at a lower reading level. As another example, an NDNS word at one reading level may be a decodable word and/or a sight word at one or more higher reading levels.

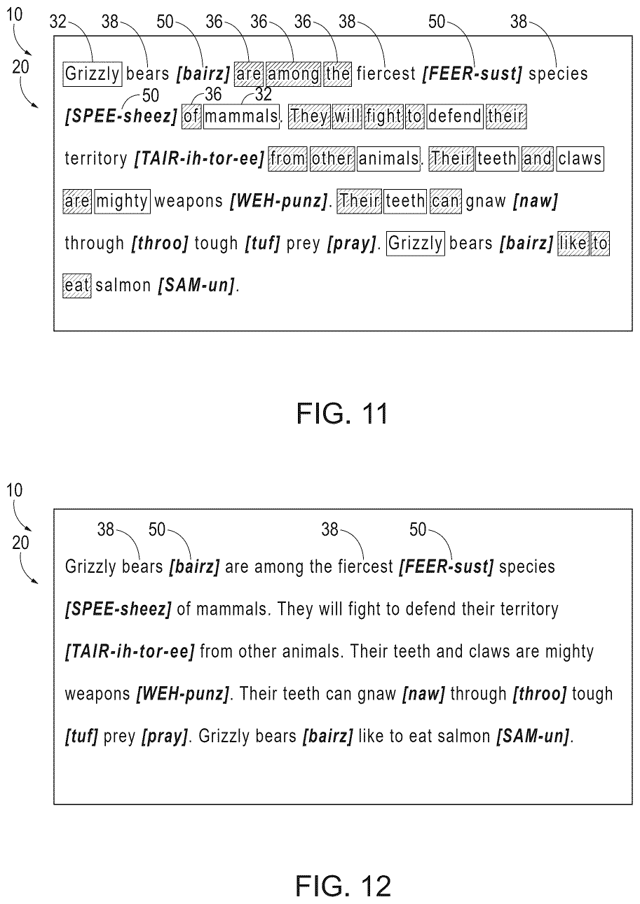

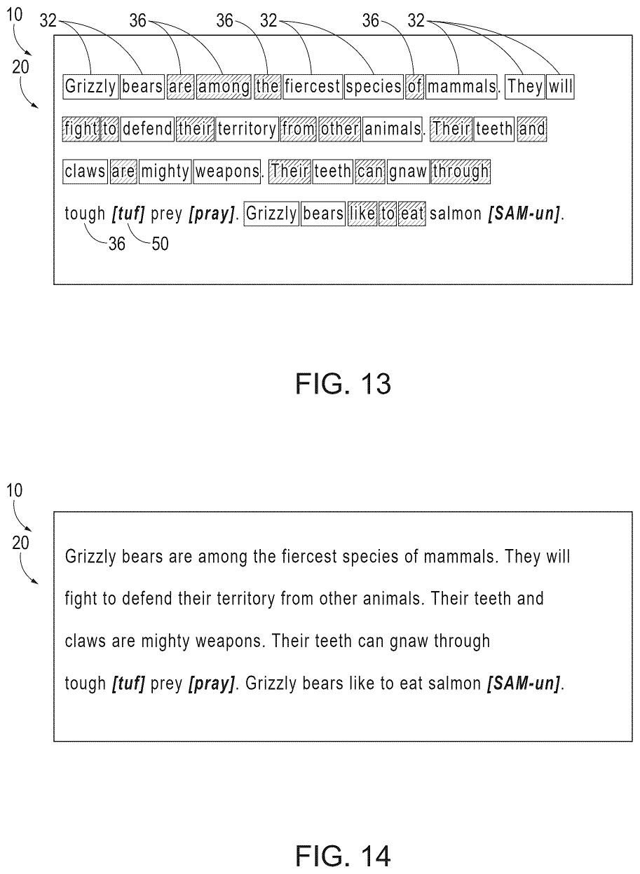

To illustrate the above, FIG. 9 illustrates the story of FIG. 8 after being categorized at a first preselected reading level, such as the purple reading level discussed herein. FIG. 10 illustrates the story of FIG. 8 with DPKs 50 presented immediately adjacent to the NDNS words from FIG. 9. FIG. 11 illustrates the story of FIG. 8 after being categorized at a second preselected reading level that is higher (i.e., more challenging) than the first preselected reading level. The example of FIG. 11 is an example of story 20 being categorized at the green reading level discussed herein. FIG. 12 illustrates the story of FIG. 8 with DPKs 50 for the NDNS words 38 from FIG. 11. FIG. 13 illustrates the story of FIG. 8 after being categorized at a third preselected reading level that is higher (i.e., more challenging) than the first and the second preselected reading levels. The example of FIG. 13 is an example of story 20 being categorized at the blue level discussed herein. FIG. 14 illustrates the story of FIG. 8 with DPKs 50 for the NDNS words 38 from FIG. 13. In FIGS. 9-14 only representative words are labeled as sight, decodable, and/or NDNS words.

Returning to FIG. 7, methods 100 according to the present disclosure may include adding illustrations to the story at 160 and/or adding other elements may be added to the system at 170. Examples of suitable illustrations are described and/or illustrated herein with respect to illustrations 72, and examples of other elements that may be added to the system are discussed and/or illustrated herein with respect to table of contents 26, description 60, master pronunciation key 62, list of phonetic elements 64, and reading level indicia 70.

At 180, the system may be embodied in a medium, such as a print and/or electronic medium. Examples of suitable mediums are disclosed herein with respect to medium 12, including print medium 14 and electronic medium 16, with a specific example being a book 80, such as a printed book 17 and/or an electronic book 18.

At 190, the embodied system may be printed, published, displayed, and/or distributed via any suitable process that is appropriate for the medium. For example, printed books 17 may be printed and delivered to retailers, purchasers, and other recipients. As another example, e-books 18 may be emailed, transmitted, or sent to purchasers and/or other recipients or made available for downloading by purchasers and/or individuals who desire to access the e-books.

Aspects of systems 10 and/or methods 100 may, but are not required to, be embodied as a computer method, computer system, or computer program product, and when so embodied may be referred to as computer-implemented systems and/or computer-implemented methods. Accordingly, aspects of the computer-implemented systems and/or methods may take the form of an entirely hardware embodiment, an entirely software embodiment (including firmware, resident software, micro-code, and the like), or an embodiment combining software and hardware aspects, all of which may generally be referred to herein as a “circuit,” “module,” or “computer system.” Furthermore, aspects of the systems 10 and/or methods 100 may take the form of a computer program product embodied in a computer-readable medium (or media) having computer-readable program code/instructions embodied thereon. Such computer program products may, for example, include, embody, display, present, and/or provide access to systems 10, stories 20 and/or books 80 (such as e-books 18) according to the present disclosure.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

The computer-readable storage medium, when present, also may be referred to herein as non-transitory computer readable storage medium. This non-transitory computer readable storage medium may include, define, house, and/or store computer-executable instructions, programs, and/or code; and these computer-executable instructions may direct, enable, and/or control processing logic thereof to perform any suitable portion, or subset, of the computer-implemented methods. As used herein, storage, or memory, devices and/or media having computer-executable instructions, as well as computer-implemented methods and other methods according to the present disclosure, are considered to be within the scope of subject matter deemed patentable in accordance with Section 101 of Title 35 of the United States Code.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code, which also may be referred to as computer program code and/or computer program instructions, embodied on a computer-readable medium may be transmitted using any appropriate medium, including but not limited to wireless, wireline, optical fiber cable, RF, and/or the like, and/or any suitable combination of these.

Computer program code for carrying out operations for aspects of the computer-implemented systems and/or computer-implemented methods may be written in one or any combination of programming languages, including an object-oriented programming language (such as Java, C++), conventional procedural programming languages (such as C), and functional programming languages (such as Haskell). Mobile apps may be developed using any suitable language, including those previously mentioned, as well as Objective-C, Swift, C#, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the computer-implemented systems and/or computer-implemented methods may be described with reference to flowchart illustrations and/or block diagrams of methods, apparatuses, systems, and/or computer program products. Each block and/or combination of blocks in a flowchart and/or block diagram may be implemented by computer program instructions. The computer program instructions may be programmed into or otherwise provided to processing logic (e.g., a processor of a general purpose computer, special purpose computer, field programmable gate array (FPGA), or other programmable data processing apparatus) to produce a machine, such that the (e.g., machine-readable) instructions, which execute via the processing logic, create means for implementing the functions/acts specified in the flowchart and/or block diagram block(s). As used herein, “processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

Additionally or alternatively, these computer program instructions may be stored in a computer-readable medium that can direct processing logic and/or any other suitable device to function in a particular manner, such that the instructions stored in the computer-readable medium produce an article of manufacture including instructions which implement the function/act specified in the flowchart and/or block diagram block(s).

The computer program instructions can also be loaded onto processing logic and/or any other suitable device to cause a series of operational steps to be performed on the device to produce a computer-implemented process such that the executed instructions provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the present disclosure. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems, special-purpose software-based systems, and/or combinations of special purpose hardware- and software-based systems that perform the specified functions or acts.

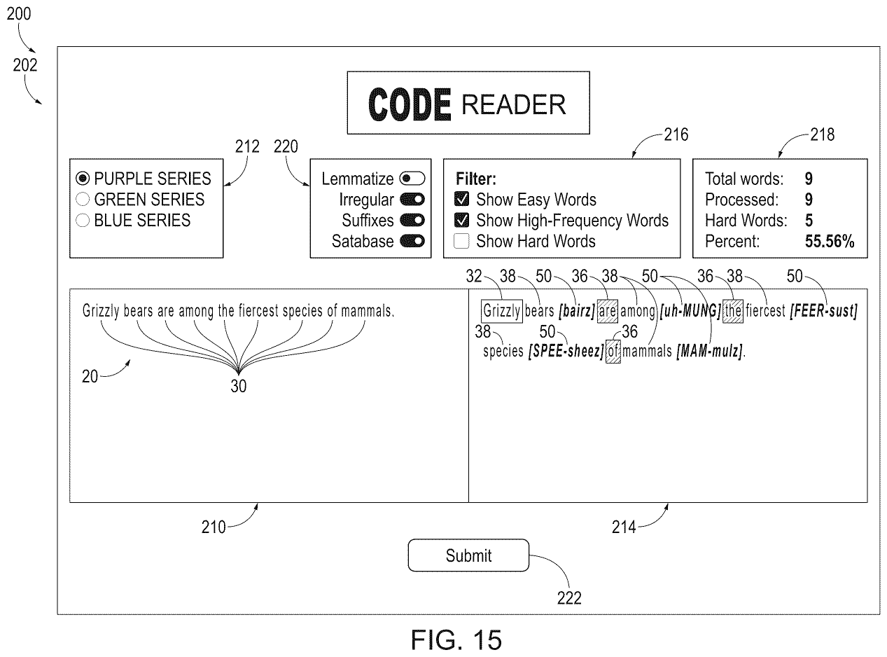

FIG. 15 illustrates an example of a user interface 202 for a computer program product 200 from which a computer-implemented method, such as a computer-implemented and/or computer-assisted version of methods 100 may be performed, at least in part, according to the present disclosure. As shown, the user interface includes a story input field 210 in which a user may construct a story 20, and a reading level selection field 212 in which the user may select a reading level for the story. Story 20 may be inputted into the story input field via any suitable mechanism or process. Examples include the user typing the story into the story input field, pasting the story into the story input field, uploading the story into the story input field, optically scanning (i.e., using a camera or image capture feature of the processing logic and/or computer program product) the story, etc.

User interface 202 further includes a system output field 214 in which the story 20 in the story input field is displayed with DPKs 50 presented immediately adjacent the NDNS words 38 in the story. In the illustrated example, the user interface also includes a categorization field 216 that a user may utilize to cause the system output field to identify one or more selected categories of the words in the story, such as sight words (referred to as high-frequency words in FIG. 15), decodable words (referred to as easy words in FIG. 15), and NDNS words (referred to as hard words in FIG. 15). User interface 202 also may include a story data field 218 in which details about the story are displayed to the user, and/or a lemmatization field 220 in which a user may cause the words in the story to be grouped by inflected or variant forms of the same word. In the example of FIG. 15, the story data field is configured to display the total number of words in the story, the number of NDNS words in the story at the selected reading level, and the percentage of words in the story that are NDNS words at the selected reading level. Story data field 218 may be configured to display more or less data about the story, with examples of other data to be calculated and displayed including the number and/or percentage of each category of the words in the story, an estimated or determined reading level of the story that is determined by the computer program product and/or the program logic associated with the user interface (collectively, the “computer system”), etc.

In FIG. 15, a portion of the story 20 from FIG. 8 is shown in story input field 210, with the purple reading level being selected as the selected reading level, and with the categorization field configured to identify (i.e., display in a different format from other categories, or types, of words in the story) sight words, decodable words, and NDNS words. In the illustrated example, 55.56% of the words in the story are NDNS words. After considering the displayed system 10 in the system output field and/or the story data in the story data field, a user may revise the type and/or number of words in the story using the story input field, select a different reading level using the reading level selection field, and/or change the types of words that are identified using the story data field. As additional examples, the user may change one or more of the DPKs that are presented immediately adjacent the NDNS words in the output field, remove one or more of the DPKs that are presented in he output field, or add additional DPKs immediately adjacent other words in the story in the output field. For instance, a user may believe a different DPK and/or different number of DPKs is/are more appropriate for the intended reader or selected reading level of the story.

The computer system may be configured to categorize the story, determine DPKs for the NDNS words at the selected reading level, to determine a reading level of the story, and/or to display the system (i.e., the story with DPKs presented immediately adjacent the NDNS words) automatically responsive to words being inputted into the story input field and a reading level being selected in the reading level selection field. Alternatively, the computer system may be configured to perform some or all of these operations responsive to receipt of a user command to do so, such as via a user selecting the “submit” button shown at 222 in FIG. 15. Submit button 222 also may be referred to as an enter or execute button or user input.

From the computer system standpoint, the computer system is configured to receive story 20 from a user via the story input field, and to either receive a selected reading level input from the user via the reading level selection field, to utilize a default (preselected) reading level, or to determine a reading level for the story, such as via one of the methods or techniques discussed herein. The computer system further is configured to categorize the words in the story at the selected reading level, to determine DPKs for the NDNS words at the selected reading level, and to display the system in the system output field. The computer system further may be configured to automatically calculate the story data, display the story data in the story data field, and/or identify specific types of words in the system output field responsive to a user input selecting such identification in the categorization and/or lemmatization fields. Responsive to receipt of a user input to do so, the computer system also may be configured to revise the words in the story to change the selected reading level of the story. For example, if a user wants to create a version of the story inputted into the input field from an initial (selected) reading level to a higher or lower reading level, the user may input a command to increase or decrease the reading level of the story, and the computer system may be configured to revise the words in the story, and the presentation of the story in the output field, accordingly. The computer system may be configured to perform live, or automatic, updates responsive to receipt of additional user inputs, such as changes to the story, changes to the selected reading level, and/or changes to the selected categorization.

When a user has completed creation of the story 20 using the computer system, the user may repeat the process for another story, or another portion of the story. The user also may selectively store the story in the computer system's memory, send the story to another user or computing device, and/or copy and paste the story into another computer program or document. The user also may perform one or more of the additional steps in method 100, and the computer system may be configured to assist the user to do so. As examples, the computer system may be configured to present the created system 20 in a medium, to create, select., edit, and/or display illustrations with the system, to add other elements to system 20, to display the system in an electronic medium, to format the system for a print medium, to save the system to the computer system's memory, to publish the system, etc.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially” and/or “at least a substantial portion of,” when modifying a degree or relationship, may include not only the recited “substantial” degree or relationship, but also the full extent of the recited degree or relationship. A substantial amount of a recited degree or relationship may include at least 60% of the recited degree or relationship. For example, an object that is at least substantially formed from a material includes objects for which at least 60% of the objects are formed from the material and also includes objects that are completely formed from the material. As another example, a first length that is at least substantially as long as a second length includes first lengths that are within 60% of the second length and also includes first lengths that are as long as the second length. Similarly, as used herein, “at least a substantial portion” of a quantity, total, or unity includes not only the recited “substantial” portion, but all the complete quantity, total, or unity. A substantial portion includes at least 60% of the quantity, total, or unity.

As used herein, “comprising,” “including,” and “having” (and conjugations thereof) are used interchangeably to mean including but not necessarily limited to, and are open-ended terms not intended to exclude additional, unrecited elements or method steps.

As used herein, terms such as “first,” “second,” and “third” are used to distinguish or identify various members of a group, or the like, and are not intended to show serial or numerical limitation.

As used herein, “processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

As used herein, a “controller” or “electronic controller” includes processing logic programmed with instructions to carry out a controlling function with respect to a control element. For example, an electronic controller may be configured to receive an input signal, compare the input signal to a selected control value or setpoint value, and determine an output signal to a control element (e.g., a motor or actuator) to provide corrective action based on the comparison. In another example, an electronic controller may be configured to interface between a host device (e.g., a desktop computer, a mainframe, etc.) and a peripheral device (e.g., a memory device, an input/output device, etc.) to control and/or monitor input and output signals to and from the peripheral device.

Illustrative, non-exclusive examples of systems, stories, books, and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

A. A system for developing reading skills, the system comprising:
a story comprising a plurality of words;
wherein the plurality of words comprises:
   (i) a plurality of sight words;
   (ii) a plurality of decodable words; and
   (iii) a plurality of non-decodable, non-sight words (“NDNS words”) that are neither sight words nor decodable words;
wherein for each of at least a substantial portion of the plurality of NDNS words, the story includes a discrete pronunciation key (DPK) immediately adjacent to at least an initial appearance of each NDNS word of the at least a substantial portion of the plurality of NDNS words.

A1. The system of paragraph A, wherein the plurality of words includes at least 500 words, at least 800 words, at least 1,000 words, at least 1,500 words, at least 2,000 words, at least 2,500 words, at least 3,000 words, at least 4,000 words, at least 5,000 words, at least 6,000 words, at least 7,000 words, at least 8,000 words, at least 9,000 words, at least 10,000 words, at most 15,000 words, at most 12,000 words, at most 10,000 words, at most 8,000 words, at most 7,500 words, at most 6,000 words, and/or at most 5,000 words.

A2. The system of any of paragraphs A-A1, wherein the plurality of words includes 1,000-5,000 words, 2,000-6,000 words, 2,500-7,500 words, 3,000-8,000 words, or 4,000-10,000 words.

A3. The system of any of paragraphs A-A2, wherein the plurality of sight words includes at least 100 sight words, at least 150 sight words, at least 200 sight words, at least 250 sight words, at least 300 sight words, at least 400 sight words, at least 500 sight words, at least 600 sight words, at least 750 sight words, at least 1,000 sight words, at least 2,000 sight words, at most 2,500 sight words, at most 1,200 sight words, at most 1,000 sight words, at most 800 sight words, at most 750 sight words, at most 600 sight words, at most 500 sight words, at most 400 sight words, and/or at most 300 sight words.

A4. The system of any of paragraphs A-A3, wherein at least a substantial portion of the sight words are included in the Dolch sight word list, the Fry sight word list, and/or the CPB sight word list.

A5. The system of any of paragraphs A-A4, wherein the plurality of sight words includes a plurality of decodable sight words and a plurality of non-decodable sight words.

A6. The system of any of paragraphs A-A5, wherein the plurality of decodable words includes at least 250 decodable words, at least 500 decodable words, at least 1,000 decodable words, at least 1,500 decodable words, at least 2,000 decodable words, at least 2,500 decodable words, at least 3,000 decodable words, at least 4,000 decodable words, at least 5,000 decodable words, at least 6,000 decodable words, at least 7,500 decodable words, at least 10,000 decodable words, at most 12,000 decodable words, at most 10,000 decodable words, at most 8,000 decodable words, at most 7,500 decodable words, at most 6,000 decodable words, at most 5,000 decodable words, at most 4,000 decodable words, and/or at most 3,000 decodable words.

A7. The system of any of paragraphs A-A6, wherein the plurality of words includes more decodable words than sight words.

A8. The system of any of paragraphs A-A7, wherein the plurality of words includes at least 4 times, at least 5 times, at least 6 times, at least 7 times, at least 8 times, at least 9 times, and/or at least 10 times more decodable words in the plurality of decodable words than sight words in the plurality of sight words.

A9. The system of any of paragraphs A-A8, wherein the plurality of decodable words is at least 50%, at least 60%, at least 70%, at least 75%, at least 80%, at most 90%, at most 85%, at most 80%, at most 75%, at most 70%, and/or at most 65% of the plurality of words.

A10. The system of any of paragraphs A-A9, wherein the plurality of words includes at least 50 NDNS words, at least 60 NDNS words, at least 75 NDNS words, at least 100 NDNS words, at least 150 NDNS words, at least 200 NDNS words, at least 250 NDNS words, at least 300 NDNS words, at least 500 NDNS words, at least 1,000 NDNS words, at least 2,000 NDNS words, at most 4,000 NDNS words, at most 2,000 NDNS words, at most 1,000 NDNS words, at most 800 NDNS words, at most 750 NDNS words, at most 600 NDNS words and/or at most 500 NDNS words.

A11. The system of any of paragraphs A-A10, wherein the plurality of NDNS words is at least 2%, at least 5%, at least 7.5%, at least 10%, at least 12.5%, at least 15%, at least 20%, at most 40%, at most 30%, at most 25%, at most 20%, at most 17.5%, at most 15%, at most 12.5%, at most 10%, and/or at most 5% of the plurality of words.

A12. The system of any of paragraphs A-A11, wherein the story includes fewer NDNS words than decodable words or sight words.

A13. The system of paragraph A12, wherein the story includes fewer NDNS words than the total of decodable words and sight words in the story.

A14. The system of any of paragraphs A-A13, wherein the number of discrete pronunciation keys in the story is at most 20%, at most 15%, at most 12%, at most 10%, at most 8%, at most 6%, at most 4%, at least 1.5%, at least 3%, at least 4%, at least 5%, at least 6%, at least 7%, at least 8%, and/or at least 10% of the plurality of words in story.

A15. The system of any of paragraphs A-A14, wherein the number of the plurality of sight words in the plurality of words is less than or greater than the number of the plurality of NDNS words in the plurality of words.

A16. The system of any of paragraphs A-A15, wherein the story additionally or alternatively is, or includes, at least one reading passage containing the plurality of words.

A17. The system of any of paragraphs A-A16, wherein the story is a narrative story.

A18. The system of any of paragraphs A-A17, wherein the story is a fiction story or a non-fiction story.

A19. The system of any of paragraphs A-A18, wherein the story is constructed to be at a preselected reading level.

A19.1. The system of paragraph A19, wherein the plurality of words are selected, at least in a part, based on the preselected reading level.

A19.2. The system of any of paragraphs A19-A19.1, wherein the preselected reading level is defined or selected, at least in part, based on the plurality of words.

A19.3. The system of any of paragraphs A19-A19.2, wherein the plurality of NDNS words correspond to and/or are selected, at least in part, based on the preselected reading level.

A19.4. The system of any of paragraphs A19-A19.3, wherein the preselected reading level is defined or selected, at least in part, based on the plurality of the NDNS words.

A19.5. The system of any of paragraphs A19-A19.4, wherein the plurality of sight words correspond to and/or are selected, at least in part, based on the preselected reading level.

A19.6. The system of any of paragraphs A19-A19.5, wherein the preselected reading level is defined or selected, at least in part, based on the plurality of sight words.

A19.7. The system of any of paragraphs A19-A19.6, wherein the plurality of decodable words correspond to and/or are selected, at least in part, based on the preselected reading level.

A19.8. The system of any of paragraphs A19-A19.7, wherein the preselected reading level is defined or selected, at least in part, based on the plurality of decodable words.

A20. The system of any of paragraphs A19-A19.8, wherein the preselected reading level is a second grade reading level, a third grade reading level, a fourth grade reading level, a fifth grade reading level, a sixth grade reading level, a seventh grade reading level, or an eighth grade reading level.

A21. The system of any of paragraphs A19-A19.8, wherein the preselected reading level is a preselected range of reading levels, optionally wherein the preselected range of reading levels is the second and third grade reading levels, the second through fourth grade reading levels, the third and fourth grade reading levels, the third through fifth grade reading levels, the fourth and fifth grade reading levels, the fourth through six grade reading levels, the fifth and sixth grade reading levels, the fifth through seventh grade reading levels, the sixth and seventh grade reading levels, the sixth through eighth grade reading levels, or the seventh and eighth grade reading levels.

A22. The system of any of paragraphs A19-A21, wherein the story includes an indicia that corresponds to the preselected reading level.

A23. The system of any of paragraphs A19-A22, wherein the indicia includes one or more of a color, a symbol, a graphic, a pattern, at least one number, at least one letter, and/or a character string.

A24. The system of any of paragraphs A-A23, wherein the story is not constructed to have repeated alternating passages at different reading levels that are constructed to be read by readers having different reading skills.

A25. The system of any of paragraphs A-A24, wherein the story discusses a single subject or topic.

A26. The system of any of paragraphs A-A25, wherein the story is divided into a plurality of chapters that each include a subset of the plurality of words and which are constructed to be read sequentially.

A27. The system of paragraph A26, wherein the story includes a table of contents that includes a plurality of entries corresponding to the plurality of chapters.

A28. The system of any of paragraphs A-A27, wherein the story includes the discrete pronunciation key immediately adjacent only a first appearance of each NDNS word in the at least a substantial portion of the plurality of NDNS words.

A29. The system of any of paragraphs A-A28, wherein the story includes the discrete pronunciation key immediately adjacent at least the first two appearances of each NDNS word in the at least a substantial portion of the plurality of NDNS words.

A30. The system of any of paragraphs A28-A29, wherein the story includes the discrete pronunciation key immediately adjacent at least a/the first appearance of each NDNS word in the at least a substantial portion of the plurality of NDNS words, but not for all appearances of each NDNS word in the at least a substantial portion of the plurality of NDNS words.

A31. The system of any of paragraphs A-A30, wherein for each of the plurality of NDNS words the story includes a discrete pronunciation key immediately adjacent to at least an initial appearance of each NDNS word of the plurality of NDNS words.

A32. The system of any of paragraphs A-A31, wherein each discrete pronunciation key is constructed to correspond to a given NDNS word of the plurality of NDNS words.

A33. The system of any of paragraphs A-A32, wherein the discrete pronunciation key contains phonetic keys for each sound in the NDNS word.

A34. The system of any of paragraphs A-A33, wherein the discrete pronunciation key is constructed to enable the reader to decipher the sounds of the letters in the NDNS word.

A35. The system of any of paragraphs A-A34, wherein each discrete pronunciation key is presented one of immediately before, immediately after, immediately above, or immediately below a corresponding NDNS word of the plurality of NDNS words.

A36. The system of any of paragraphs A-A35, wherein each discrete pronunciation key is presented in-line with a/the corresponding NDNS word of the plurality of NDNS words.

A37. The system of any of paragraphs A-A36, wherein each discrete pronunciation key is presented in a different format than a/the corresponding NDNS word of the plurality of NDNS words.

A38. The system of paragraph A37, wherein the different format includes being bounded by parentheses, at least one of a different font, a different font style, a different font size, a smaller font size, a larger font size, a different color, a lighter color, a darker color, a different degree of capitalization, a different hue, a different degree of underlining, a different degree of italicization, and/or a surrounding perimeter than a/the corresponding NDNS word of the plurality of NDNS words.

A39. The system of any of paragraphs A-A38, wherein each discrete pronunciation key is bounded by parentheses.

A40. The system of any of paragraphs A-A39, wherein the system further includes a description of how to read the story and utilize the discrete pronunciation keys.

A41. The system of paragraph A40, wherein the description is presented before the story. A42. The system of paragraph A40 or A41, wherein the description is presented after the story.

A43. The system of paragraph A40, wherein the description is contained in an introduction portion of the system.

A44. The system of any of paragraphs A-A43, wherein the system includes a plurality of illustrations.

A45. The system of paragraph A44, wherein the plurality of illustrations corresponds to a/the subject of the story.

A46. The system of any of paragraphs A44-A45, wherein the plurality of illustrations are presented concurrent with the plurality of words.

A47. The system of any of paragraphs A44-A46, wherein the plurality of illustrations are presented between passages of the plurality of words.

A48. The system of any of paragraphs A-A47, wherein at least one of the system and the story includes a reading-level indicia corresponding to a/the reading level of the story.

A49. The system of paragraph A48, wherein the reading-level indicia corresponds to a/the preselected reading level or range of reading levels for the story.

A50. The system of any of paragraphs A-A49, wherein the system includes a master pronunciation key.

A51. The system of paragraph A50, wherein the master pronunciation key includes at least a substantial portion of the discrete pronunciation keys for vowel sounds.

A52. The system of any of paragraphs A50-A51, wherein the master pronunciation key includes all of the discrete pronunciation keys for vowel sounds.

A53. The system of any of paragraphs A50-A52, wherein the master pronunciation key is presented before the story.

A54. The system of any of paragraphs A50-A53, wherein the master pronunciation key is presented after the story.

A55. The system of any of paragraphs A50-A54, wherein the system includes a hyperlink and/or URL via which the master pronunciation key may be accessed by a reader.

A56. The system of any of paragraphs A-A55, wherein the system includes a list of graphemes and/or phonemes contained in at least a substantial portion of the plurality of decodable words.

A57. The system of any of paragraphs A-A56, wherein the system includes a list of graphemes and/or phonemes contained in all of the plurality of decodable words.

A58. The system of any of paragraphs A56-A57, wherein the list of graphemes and/or phonemes is presented before the story.

A59. The system of any of paragraphs A56-A58, wherein the list of graphemes and/or phonemes is presented after the story.

A60. The system of any of paragraphs A56-A59, wherein the system includes a hyperlink and/or URL via which the list of graphemes and/or phonemes may be accessed by a reader.

A61. The system of any of paragraphs A-A60, wherein the list of graphemes and/or phonemes is embodied in a separate and/or different medium than the story.

A62. The system of any of paragraphs A56-A61, wherein the list includes a list of graphemes and/or phonemes for the selected reading level of the story.

A63. The system of paragraph A62, wherein the list further includes a list of graphemes and/or phonemes for at least one additional reading level that is different than the selected reading level of the story.

A64. The system of any of paragraphs A56-A63, wherein the system includes a hyperlink and/or URL from which the list may be accessed.

A65. The system of any of paragraphs A-A64, wherein the system does not include a glossary containing definitions of at least some of the plurality of words.

A66. The system of any of paragraphs A-A65, wherein the system includes a plurality of the stories.

A67. The system of paragraph A66, wherein at least some of the plurality of stories are constructed to be at a/the same preselected reading level.

A68. The system of any of paragraphs A66-A67, wherein at least one story of the plurality of stories is constructed to be at a different preselected reading level than at least one other story of the plurality of stories.

A69. The system of any of paragraphs A66-A68, wherein each of the plurality of stories includes an/the indicia that corresponds to the preselected reading level.

A70. The system of any of paragraphs A66-A69, wherein each story of the plurality of stories is separate from the other stories in the plurality of stories.

A71. The system of any of paragraphs A-A70, wherein the system is embodied in a medium.

A72. The system of paragraph A71, wherein the medium is a print medium.

A73. The system of paragraph A72, wherein the print medium is a printed book.

A74. The system of paragraph A71, wherein the medium is an electronic medium.

A75. The system of paragraph A74, wherein the electronic medium is an electronic book (e-book).

A76. The system of paragraph A74, wherein the electronic medium is a webpage or website.

A77. The system of any of paragraphs A-A71, wherein the system is or includes a book. A78. The system of paragraph A77, wherein the book is a printed book.

A79. The system of paragraph A77, wherein the book is an electronic book.

A80. The system of any of paragraphs A77-A79, wherein the book includes at least 40 pages, at least 48 pages, at least 64 pages, at least 80 pages, at least 100 pages, or at least 150 pages.

A81. The system of any of paragraphs A77-A80, wherein the book includes at most 500 pages, at most 400 pages, at most 300 pages, at most 200 pages, at most 175 pages, at most 150 pages, at most 125 pages, or at most 100 pages.

A82. The system of any of paragraphs A77-A81, wherein the book and/or the system is a children's chapter book.

B. A method for developing reading skills, the method comprising:
constructing a story containing a plurality of words;
categorizing the plurality of words as sight words, decodable words, and non-decodable, non-sight (“NDNS”) words for a selected reading level; and
adding discrete pronunciation keys (“DPKs”) for at least a substantial number of the NDNS words in the story immediately adjacent to the corresponding NDNS words in the story.

B1. The method of paragraph B, wherein the method includes determining the DPKs for the at least a substantial portion of the NDNS words in the story.

B2. The method of any of paragraphs B-B1, wherein the method includes determining the selected reading level after constructing the story.

B3. The method of any of paragraphs B-B2, wherein the method includes selecting a reading level and constructing the story based, at least in part, on the selected reading level.

B4. The method of any of paragraphs B-B3, wherein the method includes changing the selected reading level after constructing the story.

B5. The method of any of paragraphs B-B4, wherein the method includes changing at least some of the plurality of words in the story after categorizing the plurality of words in the story.

B6. The method of paragraph B5, wherein the changing includes increasing the number of NDNS words in the story.

B7. The method of paragraph B5, wherein the changing includes decreasing the number of NDNS words in the story.

B8. The method of paragraph B5, wherein the changing includes increasing the number of NDNS words in the story that include DPKs.

B9. The method of paragraph B5, wherein the changing includes decreasing the number of NDNS words in the story that include DPKs.

B10. The method of any of paragraphs B-B9, wherein the method further includes adding illustrations to the story.

B11. The method of any of paragraphs B-B10, wherein the method further includes embodying the system in a medium.

B12. The method of paragraph B11, wherein the medium is a print medium.

B13. The method of paragraph B12, wherein the system is embodied in a book.

B14. The method of paragraph B11, wherein the medium is an electronic medium.

B15. The method of paragraph B14, wherein the system is embodied in an electronic book.

B16. The method of any of paragraphs B-B15, wherein the system is or includes any of the systems of paragraphs A-A82.

B17. The method of any of paragraphs B-B16, wherein the method is a computer-implemented method.

C. A computer-implemented method for creating the system of any of paragraphs A-A82 and/or implementing the methods of any of paragraphs B-B17.

### INDUSTRIAL APPLICABILITY

The systems, methods, stories, books, and computer program products disclosed herein are applicable to the publishing and education industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A system for developing reading skills, the system comprising:
a story comprising a plurality of words;
wherein the plurality of words comprises:
(i) a plurality of sight words;
(ii) a plurality of decodable words; and
(iii) a plurality of non-decodable, non-sight words (“NDNS words”) that are neither sight words nor decodable words;
wherein for each of at least a substantial portion of the plurality of NDNS words, the story includes a discrete pronunciation key (DPK) immediately adjacent to at least an initial appearance of each NDNS word of the at least a substantial portion of the plurality of NDNS words.

2. The system of claim 1, wherein the story is constructed to be at a preselected reading level.

3. The system of claim 2, wherein at least one of:
(i) the plurality of words are selected, at least in part, based on the preselected reading level; and
(ii) the preselected reading level is defined or selected, at least in part, based on the plurality of words.

4. The system of claim 2, wherein at least one of:
(i) the plurality of NDNS words correspond to and/or are selected, at least in part, based on the preselected reading level; and
(ii) the preselected reading level is defined or selected, at least in part, based on the plurality of the NDNS words.

5. The system of claim 2, wherein at least one of the system and the story includes an indicia that corresponds to the preselected reading level.

6. The system of claim 1, wherein the story includes the discrete pronunciation key immediately adjacent only a first appearance of each NDNS word in the at least a substantial portion of the plurality of NDNS words.

7. The system of claim 1, wherein the story includes the discrete pronunciation key immediately adjacent at least a first appearance of each NDNS word in the at least a substantial portion of the plurality of NDNS words, but not for all appearances of each NDNS word in the at least a substantial portion of the plurality of NDNS words.

8. The system of claim 1, wherein each discrete pronunciation key is presented in a different format than a corresponding NDNS word of the plurality of NDNS words.

9. The system of claim 1, wherein the system further includes a description of how to read the story and utilize the discrete pronunciation keys.

10. The system of claim 1, wherein the system includes a plurality of illustrations.

11. The system of claim 1, wherein the system includes a master pronunciation key.

12. The system of claim 1, wherein the system includes a list of graphemes and/or phonemes contained in at least a substantial portion of the plurality of decodable words.

13. The system of claim 1, wherein the system includes a list of graphemes and/or phonemes at the preselected reading level, and further wherein the system includes a list of graphemes and/or phonemes for at least a second reading level that is different than the preselected reading level.

14. The system of claim 1, wherein the system includes a plurality of the stories, and further wherein at least one of:
(i) at least some of the plurality of stories are constructed to be at a same preselected reading level; and
(ii) at least one story of the plurality of stories is constructed to be at a different preselected reading level than at least one other story of the plurality of stories.

15. The system of claim 1, wherein the system is embodied in a print medium.

16. The system of claim 1, wherein the system is embodied in an electronic medium.

17. The system of claim 16, wherein the electronic medium includes at least one of an electronic book, a webpage, and a website.

18. A method for developing reading skills, the method comprising:
constructing a story containing a plurality of words;
categorizing the plurality of words as sight words, decodable words, and non-decodable, non-sight (“NDNS”) words for a selected reading level; and
adding discrete pronunciation keys (“DPKs”) for at least a substantial number of the NDNS words in the story immediately adjacent to the corresponding NDNS words in the story to create a system for developing reading skills.

19. The method of claim 18, wherein the method further includes determining the DPKs for at least a substantial portion of the NDNS words in the story.

20. The method of claim 18, further comprising embodying the system in a medium.

21. The method of claim 20, further comprising at least one of printing, publishing, and distributing the system embodied in the medium.

22. The method of claim 18, wherein the method is a computer-implemented method.
